(19) United States
(12) Patent Application Publication
(10) Pub. No.: US 2012/0313562 A1
(43) Pub. Date: Dec. 13, 2012

(54) BATTERY CONTROL DEVICE, BATTERY SYSTEM, ELECTRIC VEHICLE, CHARGE CONTROL DEVICE, BATTERY CHARGER, MOVABLE BODY, POWER SUPPLY SYSTEM, POWER STORAGE DEVICE, AND POWER SUPPLY DEVICE

(75) Inventors: Hiroya Murao, Hirakata-City (JP); Shinya Kataoka, Kasai-City (JP); Mika Kirimoto, Kobe-City (JP)

(73) Assignee: SANYO ELECTRIC CO., LTD., Osaka (JP)

(21) Appl. No.: 13/580,808

(22) PCT Filed: Feb. 24, 2011
(86) PCT No.: PCT/JP2011/001052

§ 371 Date: Aug. 23, 2012

(30) Foreign Application Priority Data
Feb. 25, 2010 (JP) 2010-040556

(51) Int. Cl. H02P 31/00; G06F 19/00; G01N 27/416; H02J 7/00

(52) U.S. Cl. 318/139; 320/112; 320/134; 702/63; 324/426

(57) ABSTRACT

A battery control device is connected to a plurality of battery cells. The battery control device includes a voltage value calculator, a communicator, and a voltage value updater. The voltage value calculator calculates, based on a current flowing through a plurality of battery cells, a voltage of each battery cell. If the battery control device is connected to a charge control device, the communicator receives information relating to a voltage of each battery cell, which has been detected by a voltage detector in the charge control device, from the charge control device. The voltage value updater updates the voltage calculated by the voltage value calculator based on the voltage information received by the communicator.

### TECHNICAL FIELD

The present invention relates to a battery control device and a battery system, an electric vehicle, a movable body, a power supply system, a power storage device, and a power supply device including the same, and a charge control device corresponding to the battery control device and a battery charger including the same.

### BACKGROUND ART

As a driving source of a movable body such as an electric automobile, a battery system including a plurality of battery modules capable of charge and discharge is used. The battery module has a configuration in which a plurality of battery cells (electric cells) are connected in series, for example.

In the battery system, states of charge (SOCs) of the plurality of battery cells may vary. To calculate the SOCs of the plurality of battery cells and prevent the SOCs from varying, a voltage of each battery cell is desirably measured.

Patent Document 1 discusses a battery charger and assembled battery system. The assembled battery system includes an assembled battery including a plurality of electric cells. The battery charger includes a charger, a voltage adjuster, and a control unit. The assembled battery system is connected to the battery charger. The charger charges the assembled battery. The voltage adjuster measures a voltage of each of the electric cells based on control by the control unit. The voltage adjuster adjusts the charge of each of the electric cells depending on the voltage of the electric cell. Thus, the voltages of the plurality of electric cells are prevented from varying.
[Patent Document 1] JP 2008-125297 A

### SUMMARY OF INVENTION

### Technical Problem

In the battery charger and assembled battery system discussed in Patent Document 1, the battery charger is provided with the voltage adjuster that measures the voltage of each of the electric cells in the assembled battery and adjusts the charge. Thus, the assembled battery system can be made small in size and lightweight.

However, the assembled battery system is not provided with a device that detects a voltage of each battery cell. If this assembled battery system is used for an electric vehicle, therefore, a user of the electric vehicle and various devices cannot recognize the voltage of each battery cell.

An object of the present invention is to provide a battery control device capable of obtaining a voltage of each battery cell while being prevented from becoming complex in configuration and increasing in cost, a battery system, an electric vehicle, a movable body, a power supply system, a power storage device, and a power supply device including the same, and a charge control device corresponding to the battery control device and a battery charger including the same.

### Solution to Problem

(1) According to one aspect of the present invention, a battery control device, connected to a plurality of battery cells connected in series and configured to be connectable to an external device including a voltage detector that detects a voltage of each of the plurality of battery cells, includes a calculator that calculates the voltage of each battery cell based on a current flowing through the plurality of battery cells, a receiver that receives voltage information relating to the voltage of each battery cell, which has been detected by the voltage detector, from the external device, and an updater that updates the voltage calculated by the calculator based on the voltage information received by the receiver.

In the battery control device, the calculator calculates the voltage of each battery cell based on the current flowing through the plurality of battery cells. Thus, the voltage of each battery cell can be obtained in the battery control device without providing the battery control device with the voltage detector for detecting the voltage of the battery cell.

When the battery control device is connected to the external device, the receiver receives the voltage information relating to the voltage of each battery cell, which has been detected by the voltage detector in the external device, and the updater updates the voltage calculated by the calculator based on the received voltage information.

As a result, the voltage of each battery cell can be obtained in the battery control device while preventing the battery control device from becoming complex in configuration and increasing in cost. The voltage of each battery cell, which is obtained in the battery control device, can be updated to a more accurate value at any timing.

(2) The battery control device may further include a range determiner that determines whether the voltage of each battery cell belongs to a predetermined voltage range or not, and the calculator may correct the voltage of each battery cell based on a determination result by the range determiner.

In this case, the calculated voltage is corrected based on a result of determination whether the voltage of each battery cell belongs to the predetermined voltage range or not. Even when the external device is not connected, therefore, a more accurate voltage is obtained.

(3) The range determiner may determine whether the voltage of each battery cell belongs to the voltage range or not based on a comparison result between a reference voltage and the voltage of each battery cell.

In this case, it can be determined whether the voltage of each battery cell belongs to the voltage range or not in a simple configuration. Thus, a more accurate voltage of each battery cell can be obtained without complicating the configuration of the battery control device.

(4) The battery control device may further include a connection determiner that determines that the external device has been connected to the battery control device.

In this case, the battery control device can recognize that the voltage information relating to the voltage of each battery cell can be received from the external device by determining that the external device has been connected to the battery control device. Thus, the voltage calculated based on the current can be updated to an accurate voltage actually detected by the voltage detector in the external device in a timely manner.

(5) The updater may update the voltage based on the voltage information in response to the determination of the connection by the connection determiner.

In this case, when the external device is connected, the voltage calculated based on the current can be automatically updated to an accurate voltage actually detected by the voltage detector in the external device.

(6) The battery control device may further include an external terminal connectable to the external device, and the external terminal may include a plurality of connection terminals electrically connected to an electrode terminal of each of the plurality of battery cells.

In this case, when the external terminal in the battery control device is connected to the external device, the external device is electrically connected to the electrode terminal of each battery cell. Thus, the external device can be electrically connected easily to the electrode terminals of the plurality of battery cells. As a result, the external device can easily detect the voltage of each of the plurality of battery cells.

(7) The battery control device may further include an outputter that outputs information relating to a charge state of each battery cell. In this case, the user of the battery control device or the external device can easily recognize the information relating to the charge state of each battery cell.

(8) According to another aspect of the present invention, a battery system includes a plurality of battery cells connected in series, and the battery control device according to the above-mentioned invention that is connected to the plurality of battery cells.

In the battery system, the voltage of each battery cell can be calculated based on the current without providing the battery control device according to the above-mentioned invention with the voltage detector for detecting the voltage of each battery cell. When the external device is connected to the battery control device, the voltage calculated based on the current is updated to an accurate voltage actually detected by the voltage detector in the external device.

As a result, the voltage of each battery cell can be obtained in the battery system while preventing the battery system from becoming complex in configuration and increasing in cost. The voltage of each battery cell obtained in the battery system can be updated to an accurate value at any timing.

(9) According to still another aspect of the present invention, an electric vehicle includes a plurality of battery cells connected in series, the battery control device according to the above-mentioned invention that is connected to the plurality of battery cells, a motor that is driven with electric power from the plurality of battery cells, and a drive wheel that rotates with a torque generated by the motor.

In the electric vehicle, the motor is driven with the electric power from the plurality of battery cells. The drive wheel rotates with the torque generated by the motor so that the electric vehicle moves.

The voltage of each battery cell can be calculated based on the current without providing the battery control device according to the above-mentioned invention with the voltage detector for detecting the voltage of the battery cell. Further, when the external device is connected to the battery control device, the voltage calculated based on the current is updated to an accurate voltage actually detected by the voltage detector in the external device.

Therefore, the electric vehicle need not be provided with the voltage detector for detecting the voltage of each battery cell. This can prevent the electric vehicle from becoming complex in configuration and increasing in cost.

(10) According to still another aspect of the present invention, a charge control device configured to be connectable as the external device to the battery control device according to the above-mentioned invention and a plurality of battery cells includes a voltage detector that detects a voltage of each of the plurality of battery cells, and a transmitter that transmits voltage information relating to the voltage detected by the voltage detector to the battery control device.

If this charge control device is connected to the battery control device according to the above-mentioned invention and the plurality of battery cells, the voltage detector detects the voltage of each of the plurality of battery cells, and the transmitter transmits the voltage information relating to the detected voltage to the battery control device.

Thus, the battery control device according to the above-mentioned invention can receive the voltage information from the charge control device, and update the voltage calculated based on the current based on the voltage information.

As a result, the voltage of each battery cell can be obtained in the battery control device while preventing the battery control device from becoming complex in configuration and increasing in cost. The voltage of each battery cell can be updated to a more accurate value at any timing by connecting the charge control device to the battery control device.

In this case, the battery control device need not be provided with the voltage detector for detecting the voltage of each battery cell. This prevents the battery control device from becoming complex in configuration and increasing in cost.

The charge control device can be used in common for the plurality of battery control devices. Therefore, the overall cost of the plurality of battery control devices and the charge control device can be reduced.

(11) According to still another aspect of the present invention, a battery charger includes a charger for charging a plurality of battery cells, and the charge control device according to the above-mentioned invention that is configured to be connectable to the plurality of battery cells.

If the battery charger is connected to the battery control device according to the above-mentioned invention and the plurality of battery cells, the charger can charge the plurality of battery cells. The voltage detector detects the voltage of each of the plurality of battery cells, and the transmitter transmits the voltage information relating to the detected voltage to the battery control device.

Thus, the battery control device according to the above-mentioned invention can receive the voltage information from the charge control device, and update the voltage calculated based on the current based on the voltage information.

As a result, the voltage of each battery cell can be obtained in the battery control device while preventing the battery control device from becoming complex in configuration and increasing in cost. The voltage of each battery cell can be updated to a more accurate voltage at any timing by connecting the battery charger to the battery control device.

In this case, the battery control device need not be provided with the voltage detector for detecting the voltage of each battery cell. This prevents the battery control device from becoming complex in configuration and increasing in cost.

The battery charger can be used in common for the plurality of battery control devices. Therefore, the overall cost of the plurality of battery control devices and the battery charger can be reduced.

(12) According to still another aspect of the present invention, a movable body includes a plurality of battery cells connected in series, the battery control device according to the one aspect of the present invention that is connected to the plurality of battery cells, a movable main body, and a power source that converts electric power from the plurality of battery cells into power for moving the movable main body.

In the movable body, the power source converts the electric power from the plurality of battery cells connected in series into the power, and the movable main body moves with the electric power.

The voltage of each battery cell can be calculated based on the current without providing the battery control device according to the above-mentioned invention with the voltage detector for detecting the voltage of each battery cell. Further, when the external device is connected to the battery control device, the voltage calculated based on the current is updated to an accurate voltage actually detected by the voltage detector in the external device.

Therefore, the movable body need not be provided with the voltage detector for detecting the voltage of each battery cell. This can prevent the movable body from becoming complex in configuration and increasing in cost.

(13) According to still another aspect of the present invention, a charging system includes a plurality of battery cells connected in series, the battery control device according to the one aspect of the present invention that is connected to the plurality of battery cells, and the battery charger according to the still other aspect of the present invention that is connected to the plurality of battery cells.

In the charging system, the charger in the battery charger can charge the plurality of battery cells. The voltage detector in the battery charger detects the voltage of each of the plurality of battery cells, and the transmitter in the battery charger transmits the voltage information relating to the detected voltage to the battery control device.

Thus, the battery control device can receive the voltage information from the battery charger, and update the voltage calculated based on the current based on the voltage information. As a result, the voltage of each battery cell can be obtained in the battery control device while preventing the battery control device from becoming complex in configuration and increasing in cost.

In this case, the battery control device need not be provided with the voltage detector for detecting the voltage of each battery cell. This prevents the battery control device from becoming complex in configuration and increasing in cost. The battery charger can be used in common for the plurality of battery control devices. Therefore, the overall cost of the plurality of battery control devices and the battery charger can be reduced.

(14) According to still another aspect of the present invention, a power storage device includes a plurality of battery cells connected in series, the battery control device according to the one aspect of the present invention that is connected to the plurality of battery cells, and a system controller that performs control relating to charge or discharge of the plurality of battery cells.

In the power storage device, the system controller performs control relating to charge or discharge of the plurality of battery cells. Thus, the plurality of battery cells can be prevented from being deteriorated, overdischarged, and overcharged.

When the external device is connected to the battery control device, the voltage calculated based on the current is updated to an accurate voltage actually detected by the voltage detector in the external device.

As a result, the voltage of each battery cell can be obtained in the power storage device while preventing the power storage device from becoming complex in configuration and increasing in cost. The voltage of each battery cell obtained in the power storage device can be updated to an accurate value at any timing.

(15) According to still another aspect of the present invention, a power supply device connectable to an external object includes the power storage device according to the still other aspect of the present invention, and a power conversion device that is controlled by the system controller in the power storage device and converts electric power between the plurality of battery cells in the power storage device and the external object.

In the power supply device, the power conversion device converts electric power between the plurality of battery cells and the external object. The system controller in the power storage device controls the power conversion device so that control relating to charge or discharge of the plurality of battery cells is performed. This can prevent the plurality of battery cells from being deteriorated, overdischarged, and overcharged.

When the external device is connected to the battery control device, the voltage calculated based on the current is updated to an accurate voltage actually detected by the voltage detector in the external device.

As a result, the voltage of each battery cell can be obtained in the power supply device while preventing the power supply device from becoming complex in configuration and increasing in cost. The voltage of each battery cell obtained in the power supply device can be updated to an accurate value at any timing.

### Advantageous Effects of Invention

According to the present invention, a voltage of each battery cell can be obtained while preventing a battery control device, a battery system, an electric vehicle, a charge control device, a battery charger, a movable body, a power supply system, a power storage device, and a power supply device from becoming complex in configuration and increasing in cost.

### BRIEF DESCRIPTION OF DRAWINGS

FIG. 1 is a block diagram illustrating a configuration of a battery system and a battery charger according to a first embodiment.

FIG. 2 is a block diagram mainly illustrating a configuration of a charge control device illustrated in FIG. 1.

FIG. 3A is a block diagram illustrating a configuration of a calculator illustrated in FIG. 1.

FIG. 3B is a block diagram illustrating a configuration of a voltage range determiner illustrated in FIG. 3A.

FIG. 4 is a flowchart illustrating voltage range determination processing by a voltage range determiner.

FIG. 5 is a diagram illustrating states of switching elements.

FIG. 6 is a diagram illustrating a relationship between a terminal voltage of a battery cell and a voltage range.

FIG. 7 is a diagram illustrating a relationship between a comparison result of a comparator and a voltage range.

FIG. 8 is a flowchart illustrating SOC calculation processing performed by a battery control device.

FIG. 9 is a flowchart illustrating SOC calculation processing performed by a battery control device.

FIG. 10 is a flowchart illustrating SOC calculation processing performed by a battery control device.

FIG. 11 illustrates a relationship between an SOC and an OCV of a battery cell.

FIG. 12 is a flowchart illustrating SOC calculation processing by a battery control device during charge.

FIG. 13 is a flowchart illustrating charge and battery cell voltage detection processing for battery cells by a charge control device.

FIG. 14 is a flowchart illustrating charge and battery cell voltage detection processing for battery cells by a charge control device.

FIG. 15 is a block diagram illustrating a configuration of an electric automobile according to a second embodiment.

FIG. 16 is a block diagram illustrating a configuration of a power supply device according to a third embodiment.

FIG. 17 is a block diagram illustrating a configuration of a battery charger corresponding to the power supply device illustrated in FIG. 16.

FIG. 18 is a block diagram illustrating another configuration of a processor.

FIG. 19 is a diagram illustrating an example of an equivalent circuit of a battery cell.

### DESCRIPTION OF EMBODIMENTS

### [1] First Embodiment

The embodiments of the present invention will be described in detail referring to the drawings. The embodiments below describe a battery control device, a battery system, an electric vehicle, a charge control device, a battery charger, a movable body, a power supply system, a power storage device, and a power supply device. A battery control device, a battery system, an electric vehicle, and a charge control device, and a battery charger according to a first embodiment will be described below with reference to the drawings. The battery control device according to the present embodiment is used as a part of a constituent element of the battery system loaded in the electric vehicle using electric power as a driving source, to calculate a charge state of each battery cell connected in series. The electric vehicle includes a battery electric vehicle and a plug-in hybrid electric vehicle. In the present embodiment, the electric vehicle is a battery electric vehicle.

In the following description, an amount of electric charges stored in the battery cell in a full charge state is referred to as a full charge capacity. An amount of electric charges stored in the battery cell in any state is referred to as a remaining capacity. Further, the ratio of the remaining capacity to the full charge capacity of the battery is referred to as a state of charge (SOC). In the present exemplary embodiment, the SOC of the battery cell is used as an example of a charge state of the battery cell.

(1) Configuration of Battery System and Charger

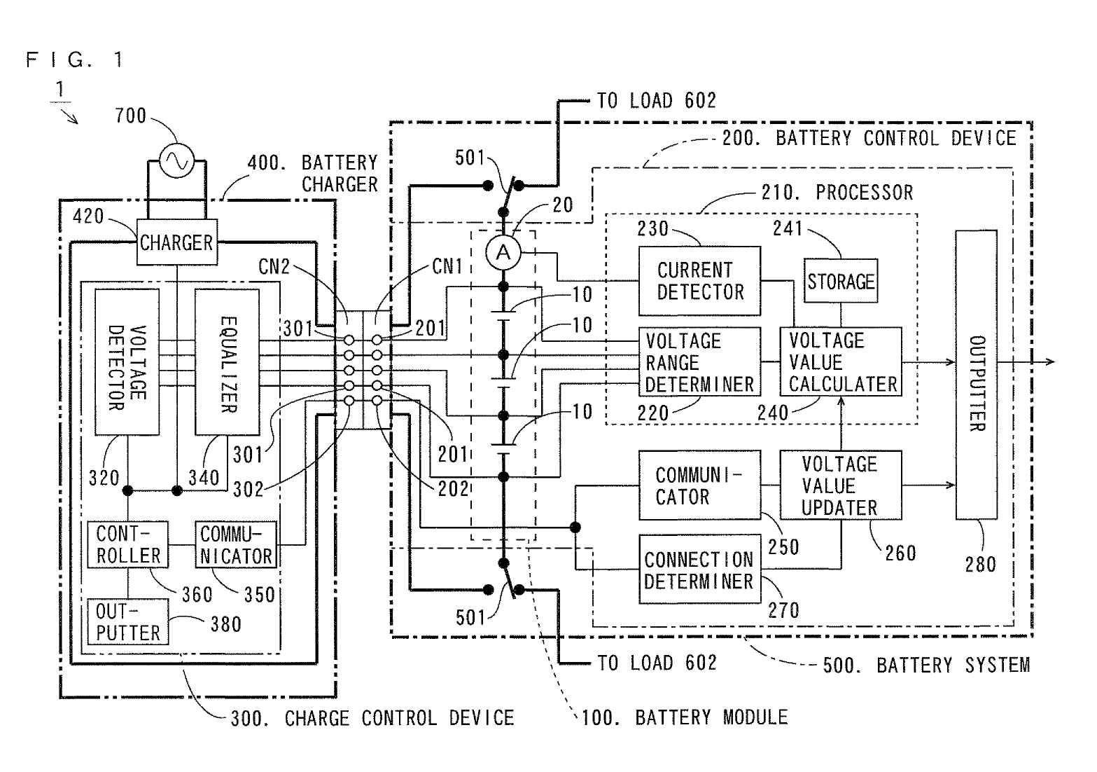

FIG. 1 is a block diagram illustrating a configuration of a battery system and a battery charger according to a first embodiment. In the present embodiment, the battery system 500 includes a battery module 100 and a battery control device 200, and is connected to an electric vehicle (a load 602 of an electric automobile 600), described below. When the battery module 100 is charged, the battery system 500 is connected to a battery charger 400. The battery system 500 includes a switch 501. The battery system 500 is selectively connected to the electric vehicle or the battery charger 400 by switching a switch 501. The battery system 500 and the battery charger 400 are connected to each other so that a charging system 1 is configured. While an example in which the charging system 1 is used for the electric vehicle in the present embodiment, the charging system 1 can also be used for an electric storage device or consumer equipment including a plurality of battery cells 10 capable of charge and discharge.

The battery module 100 includes a plurality of battery cells 10 and a current sensor 20. In the battery module 100, the plurality of battery cells 10 and the current sensor 20 are connected in series. Each battery cell 10 is a secondary battery. In this example, a lithium ion battery is used as the secondary battery.

The battery control device 200 includes a processor 210, a communicator 250, a voltage value updater 260, a connection determiner 270, and an outputter 280. The battery control device 200 includes an external connector CN1. The external connector CN1 has a plurality of connection terminals 201 and a connection terminal 202.

The processor 210 includes a voltage range determiner 220, a current detector 230, a voltage value calculator 240, and a storage 241. The voltage range determiner 220 is connected to a positive electrode terminal and a negative electrode terminal of each battery cell 10 in the battery module 100. The positive electrode terminals and the negative electrode terminals of the plurality of battery cells 10 are respectively connected to the plurality of connection terminals 201 of the external connector CN1. The communicator 250 and the connection determiner 270 are connected to the connection terminal 202 of the external connector CN1.

The storage 241 includes a nonvolatile memory such as an EEPROM (Electrically Erasable and Programmable Read Only Memory). The storage 241 stores the SOC of each battery cell 10, for example. The outputter 280 gives a value of the SOC of each battery cell 10 and a value of a current flowing through the plurality of battery cells 10, which are obtained by processing, described below, to a main controller 608 in the electric automobile 600, described below. The outputter 280 includes a communication interface such as a CAN (Controller Area Network). The outputter 280 outputs information relating to a charge state of the battery cell 10 to a display device such as a liquid crystal display device by CAN communication. Thus, a user of the battery control device 200 or a charge control device 300 can easily recognize information relating to the charge state of each battery cell 10. The CAN communication is also used between the battery control device 200 and the main controller 608 in the electric automobile 600, described below.

The connection determiner 270 determines that the battery system 500 is connected to the battery charger 400. When the battery system 500 is connected to the battery charger 400, the voltage value updater 260 updates a value of a terminal voltage of each battery cell 10, which is calculated by the processor 210, as described below, based on a value of a terminal voltage of the battery cell 10, which is given from the battery charger 400. Details of the battery control device 200 will be described below.

The battery charger 400 includes a charger 420 and the charge control device 300. The charger 420 includes an electronic circuit such as an AC/DC converter (alternating current/direct current converter), and is connected to an external power supply 700 such as a commercial power supply. The battery charger 400 converts an AC voltage supplied from the external power supply 700 into a DC voltage, and feeds the DC voltage to the battery module 100 in the battery system 500, to charge the plurality of battery cells 10.

The charge control device 300 includes a voltage detector 320, an equalizer 340, a communicator 350, a controller 360, and an outputter 380. The charge control device 300 includes an external connector CN2. The external connector CN2 has a plurality of connection terminals 301 and a connection terminal 302. The external connector CN2 in the charge control device 300 is connected to the external connector CN1 in the battery control device 200 so that the plurality of connection terminals 201 of the external connector CN1 and the plurality of connection terminals 301 of the external connector CN2 are respectively connected to each other while the connection terminal 202 of the external connector CN1 and the connection terminal 302 of the external connector CN2 are connected to each other.

The equalizer 340 is connected to the plurality of connection terminals 301 of the external connector CN2. The equalizer 340 is connected to the voltage detector 320. The communicator 350 is connected to the connection terminal 302 of the external connector CN2.

The external connector CN1 in the battery control device 200 and the external connector CN2 in the charge control device 300 are connected to each other so that the charge control device 300 can be easily electrically connected to the positive electrode terminal and the negative electrode terminal of each of the plurality of battery cells 10. In this case, the voltage detector 320 in the charge control device 300 can easily detect each of the terminal voltages of the plurality of battery cells 10. The equalizer 340 can easily perform equalization processing for the plurality of battery cells 10, described below.

The controller 360 detects that the battery module 100 in the battery system 500 has been connected to the battery charger 400 via the equalizer 340 and the voltage detector 320. The communicator 350 transmits a connection signal indicating that the battery module 100 has been connected to the battery charger 400 to the connection determiner 270 in the battery system 500. In this case, the battery charger 400 is provided with a mechanical or electrical switch that operates when the battery system 500 is connected to the battery charger 400. The communicator 350 transmits the connection signal in response to an operation of the switch in the battery charger 400.

(2) Configuration of Charge Control Device

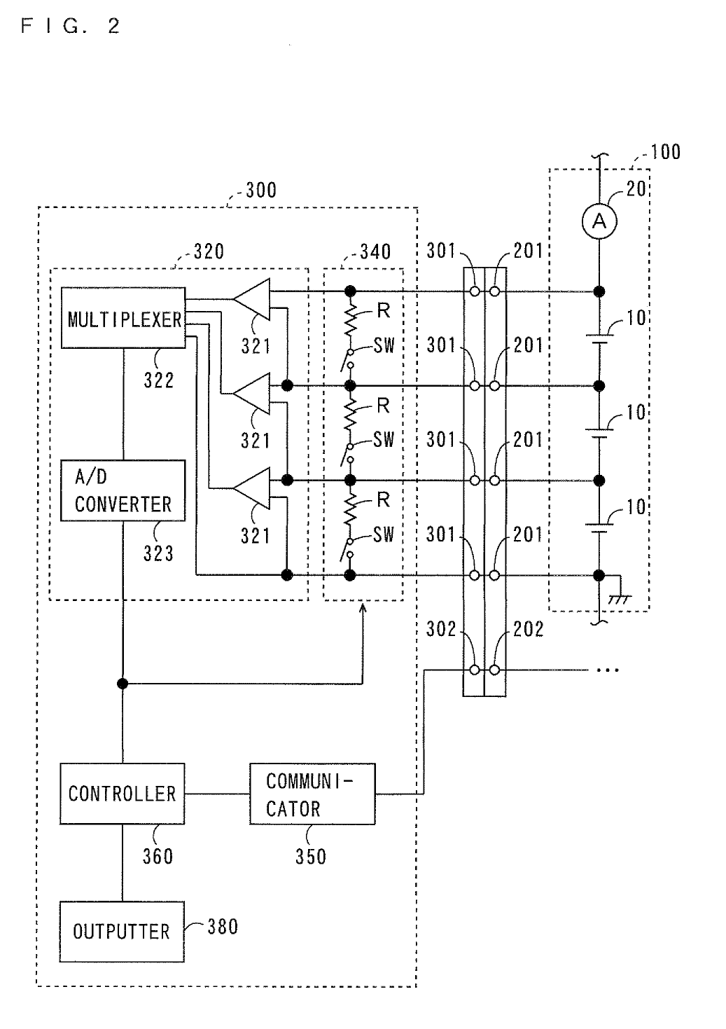

FIG. 2 is a block diagram mainly illustrating a configuration of the charge control device 300 illustrated in FIG. 1. As illustrated in FIG. 2, the equalizer 340 includes a plurality of resistors R and switching elements SW. A series circuit including the resistor R and the switching element SW is connected between the adjacent two connection terminals 301 of the external connector CN2. Thus, the resistor R and the switching element SW are connected in series between the positive electrode terminal and the negative electrode terminal of each battery cell 10 in the battery module 100 with the external connector CN2 connected to the external connector CN1. The controller 360 controls ON/OFF of the switching element SW. In a normal state, the switching element SW is OFF.

The voltage detector 320 includes a plurality of differential amplifiers 321, a multiplexer 322, and an ND converter (Analog-to-Digital Converter) 323.

Each of the differential amplifiers 321 has two input terminals and an output terminal. Each of the differential amplifiers 321 differentially amplifies voltages respectively input to the two input terminals, and outputs the amplified voltages from the output terminal. The two input terminals of each of the differential amplifiers 321 are connected between the adjacent two connection terminals 301 of the external connector CN2. Thus, the two input terminals of each of the differential amplifiers 321 are respectively connected to the positive electrode terminal and the negative electrode terminal of the corresponding battery cell 10 with the external connector CN2 connected to the external connector CN1.

Each of the differential amplifiers 321 differentially amplifies a voltage of the corresponding battery cell 10. An output voltage of each of the differential amplifiers 321 corresponds to the terminal voltage of the corresponding battery cell 10. The terminal voltages output from the plurality of differential amplifiers 321 are fed to the multiplexer 322. The multiplexer 322 sequentially outputs the terminal voltages fed from the plurality of differential amplifiers 321 to the A/D converter 323. The A/D converter 323 converts the terminal voltage output from the multiplexer 322 into a digital voltage value, and feeds the digital voltage value to the controller 360.

The controller 360 includes a CPU (Central Processing Unit) and a memory, or a microcomputer, for example. The controller 360 turns on, when it detects that the terminal voltage of the given battery cell 10 is higher than the terminal voltage of the other battery cell 10, the switching element SW connected to the battery cell 10 having the higher terminal voltage. Thus, a part of electric charges with which the battery cell 10 is charged is discharged via the resistor R.

When the terminal voltage of the battery cell 10 falls to become substantially equal to the terminal voltage of the other battery cell 10, the controller 360 turns off the switching element SW connected to the battery cell 10. Thus, open voltages of all the battery cells 10 are equalized.

The outputter 380 includes a display device such as a liquid crystal display device. The controller 360 displays the terminal voltage of each battery cell 10 on the outputter 380 while feeding the terminal voltage of the battery cell 10 to the communicator 350. The communicator 350 transmits voltage information representing the terminal voltage of each battery cell 10, which has been given from the controller 360, to the communicator 250 in the battery system 500 illustrated in FIG. 1 via the connection terminal 302 of the external connector CN2 and the connection terminal 202 of the external connector CN1 with the external connector CN2 connected to the external connector CN1.

Thus, the voltage detector 320 has a function of detecting the terminal voltage of each battery cell 10 with high precision while having a function of equalizing the open voltage of the plurality of battery cells 10.

(3) Configuration of Processor

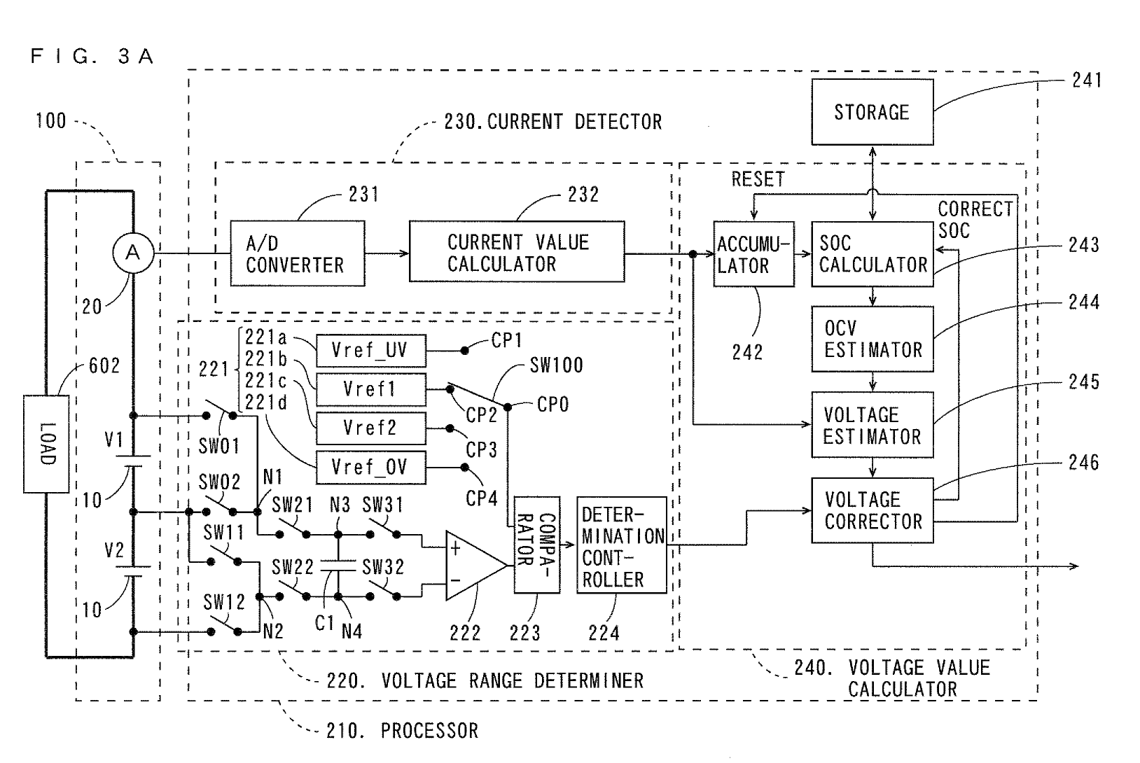

FIG. 3A is a block diagram illustrating a configuration of the voltage range determiner 220, the current detector 230, and the voltage value calculator 240 illustrated in FIG. 1. In an example illustrated in FIG. 3A, the battery module 100 including the two battery cells 10 will be described to simplify the description. The terminal voltage of one of the battery cells 10 is V1, and the terminal voltage of the other battery cell 10 is V2.

As illustrated in FIG. 3A, the voltage detector 230 includes an A/D converter 231 and a current value calculator 232. A current sensor 20 in the battery module 100 outputs a value of the current flowing through the plurality of battery cells 10 as a voltage. The A/D converter 231 converts an output voltage of the current sensor 20 into a digital value. The current value calculator 232 calculates the value of the current based on the digital value obtained by the A/D converter 231.

The voltage range determiner 220 includes a reference voltage unit 221, a differential amplifier 222, a comparator 223, a determination controller 224, a plurality of switching elements SW01, SW02, SW11, SW12, SW21, SW22, SW31, SW32, and SW100, and a capacitor C1. Each of the switching elements SW01, SW02, SW11, SW12, SW21, SW22, SW31, SW32, and SW100 is composed of a transistor, for example.

The differential amplifier 222 has two input terminals and an output terminal. The switching element SW01 is connected between the positive electrode terminal of one of the battery cells 10 and a node N1, and the switching element SW02 is connected between the positive electrode terminal of the other battery cell 10 and the node N1. The switching element SW11 is connected between the negative electrode terminal of one of the battery cells 10 and a node N2, and the switching element SW12 is connected between the negative electrode terminal of the other battery cell 10 and the node N2. The switching element SW21 is connected between the node N1 and a node N3, and the switching element SW22 is connected between the node N2 and a node N4. The capacitor C1 is connected between the node N3 and the node N4. The switching element SW31 is connected between the node N3 and one of the input terminals of the differential amplifier 222, and the switching element SW32 is connected between the node N4 and the other input terminal of the differential amplifier 222. The differential amplifier 222 differentially amplifies voltages respectively input to the two input terminals, and outputs the amplified voltages from the output terminal. An output voltage of the differential amplifier 222 is fed to one of input terminals of the comparator 223.

The switching element SW100 has a plurality of terminals CP0, CP1, CP2, CP3, and CP4. The reference voltage unit 221 includes four reference voltage outputters 221a, 221b, 221c, and 221d. The reference voltage outputters 221a to 221d respectively output a lower-limit voltage Vref_UV, a lower-side intermediate voltage Vref1, an upper-side intermediate voltage Vref2, and an upper-limit voltage Vref_OV as reference voltages to the terminals CP1, CP2, CP3, and CP4. The upper-limit voltage Vref_OV is higher than the upper-side intermediate voltage Vref2, the upper-side intermediate voltage Vref2 is higher than the lower-side intermediate voltage Vref1, and the lower-side intermediate voltage Vref1 is higher than the lower-limit voltage Vref_UV. The lower-side intermediate voltage Vref1 is 3.70 [V], for example, and the upper-side intermediate voltage Vref2 is 3.75 [V], for example.

The switching element SW100 is switched so that one of the plurality of terminals CP1 to CP4 is connected to the terminal CP0. The terminal CP0 of the switching element SW100 is connected to the other input terminal of the comparator 223. The comparator 223 compares the magnitudes of the voltages input to the two input terminals, and outputs a signal representing a comparison result from the output terminal.

In this example, when the output voltage of the differential amplifier 222 is not less than a voltage of the terminal CP0, the comparator 223 outputs a logical “1” (e.g., high-level) signal. When the output voltage of the differential amplifier 222 is lower than the voltage of the terminal CP0, the comparator 223 outputs a logical “0” (e.g., low-level) signal.

The determination controller 224 controls switching among the plurality of switching elements SW01, SW02, SW11, SW12, SW21, SW22, SW31, SW32, and SW100 while determining in which of a plurality of voltage ranges a voltage of the battery cell 10 in the battery module 100 exists based on the output signal of the comparator 223. Voltage range determination processing for the battery cell 10 will be described below.

The voltage value calculator 240 includes an accumulator 242, an SOC calculator 243, an OCV estimator 244, a voltage estimator 245, and a voltage corrector 246.

The accumulator 242 acquires respective values of the currents flowing through the plurality of battery cells 10 from the current detector 230 for each predetermined period of time, and accumulates the acquired values of the currents to calculate a current accumulated value.

The SOC calculator 243 calculates, based on the SOC of each battery cell 10 stored in the storage 241 and the current accumulated value calculated by the accumulator 242, a value of the SOC at the current time point of the battery cell 10. The SOC calculator 243 then calculates, based on a value of the SOC fed from the voltage corrector 246, described below, and the current accumulated value calculated by the accumulator 242, the SOC at the current time point of each battery cell 10.

The OCV estimator 244 estimates, based on the SOC of each battery cell 10, which has been calculated by the SOC calculator 243, an open voltage (OCV) at the current time point of the battery cell 10.

The voltage estimator 245 estimates, based on the value of the current flowing through the plurality of battery cells 10, which has been calculated by the current value calculator 232, and the OCV of the battery cell 10, which has been estimated by the OCV estimator 244, the terminal voltage at the current time point of the battery cell 10.

The voltage corrector 246 includes a timer (not illustrated). The voltage corrector 246 corrects, based on the voltage range of each battery cell 10, which has been determined by the determination controller 224, the terminal voltage at the current time point of the battery cell 10, which has been estimated by the voltage estimator 245, corrects the OCV at the current time point based on the corrected terminal voltage, and corrects the SOC at the current time point of the battery cell 10 based on the corrected OCV. Information relating to a charge state such as the corrected SOC and terminal voltage of each battery cell 10 may be displayed on a display device by being output from the outputter 280 illustrated in FIG. 1.

The voltage corrector 246 feeds the corrected SOC at the current time point of each battery cell 10 to the SOC calculator 243 while resetting the current accumulated value calculated by the accumulator 242. Further, the voltage value updater 260 illustrated in FIG. 1 updates the terminal voltage at the current time point of each battery cell 10, which has been corrected by the voltage corrector 246, when given the value of the terminal voltage of the battery cell 10 from the battery charger 400.

In the present embodiment, the voltage value calculator 240 is implemented by a CPU (Central Processing Unit) and hardware such as a memory, and software such as a computer program. The accumulator 242, the SOC calculator 243, the OCV estimator 244, the voltage estimator 245, and the voltage corrector 246 correspond to a module of a computer program. In this case, the CPU executes a computer program stored in the memory, to implement functions of the accumulator 242, the SOC calculator 243, the OCV estimator 244, the voltage estimator 245, and the voltage corrector 246. Some or all of the accumulator 242, the SOC calculator 243, the OCV estimator 244, the voltage estimator 245, and the voltage corrector 246 may be implemented by hardware.

Similarly, in the present embodiment, the determination controller 224 and the current value calculator 232 are implemented by hardware such as a CPU and a memory, and software such as a computer program. The determination controller 224 and the current value calculator 232 correspond to a module of the computer program. In this case, the CPU executes the computer program stored in the memory, to implement functions of the determination controller 224 and the current value calculator 232. Either one or both of the determination controller 224 and the current value calculator 232 may be implemented by hardware.

(4) Voltage Range Determination Processing for Battery Cell

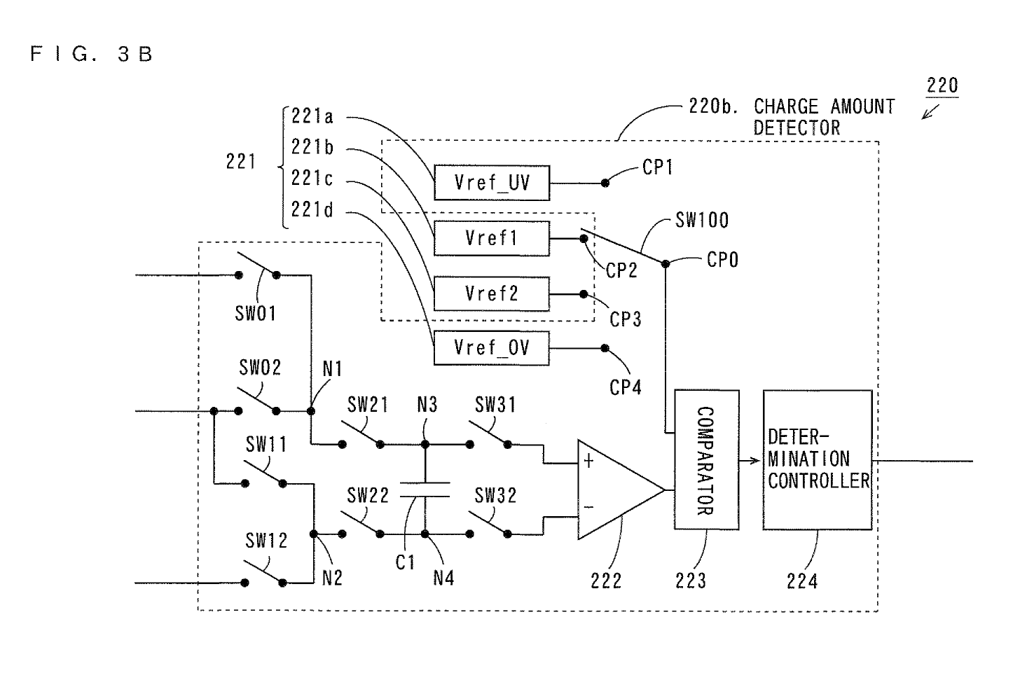

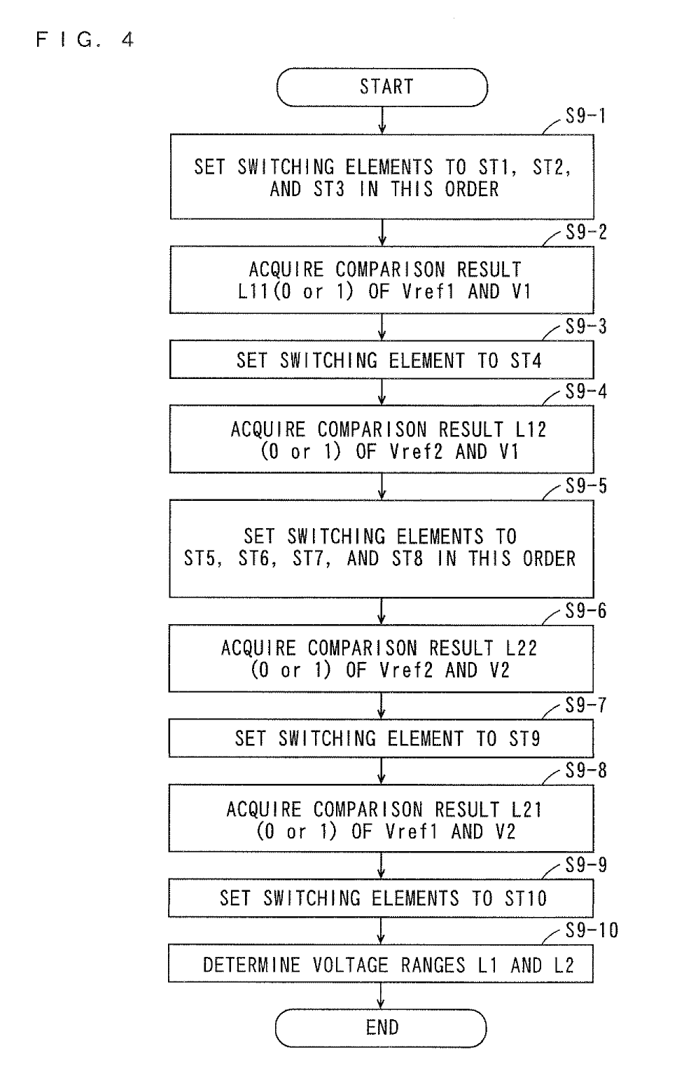

Voltage range determination processing for the battery cell 10 by the determination controller 224 will be described. FIG. 4 is a flowchart illustrating the voltage range determination processing by the determination controller 224. In the present embodiment, the CPU constituting the determination controller 224 executes a voltage range determination processing program stored in the memory so that the voltage range determination processing is performed. FIG. 5 is a diagram illustrating states of the switching elements SW01, SW02, SW11, SW12, SW21, SW22, SW31, SW32, and SW100. The determination controller 224 previously stores the state illustrated in FIG. 5 as data.

As illustrated in FIGS. 4 and 5, the determination controller 224 sets the switching elements SW01, SW02, SW11, SW12, SW21, SW22, SW31, SW32, and SW100 to states ST1, ST2, and ST3 in this order (step S9-1). In the states ST1, ST2, and ST3, the switching element SW100 is switched to the terminal CP2. Thus, the lower-side intermediate voltage Vref1 from the reference voltage outputter 221b is fed to the comparator 223.

In the state ST1, the switching elements SW01, SW11, SW21, and SW22 are turned on, and the switching elements SW02, SW12, SW31, and SW32 are turned off. Thus, the capacitor C1 is charged with the terminal voltage V1 of one of the battery cells 10.

In the state ST2, the switching elements SW21 and SW22 are then turned off. Thus, the capacitor C1 is separated from the battery cell 10.

Then, in the state ST3, the switching elements SW31 and SW32 are turned on. Thus, a voltage of the capacitor C1 is fed as the terminal voltage V1 of one of the battery cells 10 to the comparator 223.

In this case, the comparator 223 compares the lower-side intermediate voltage Vref1 and the terminal voltage V1 of one of the battery cells 10, and outputs a logical “1” or “0” signal representing a comparison result L11. The determination controller 224 acquires the comparison result L11 of the lower-side intermediate voltage Vref1 and the terminal voltage V1 of one of the battery cells 10 (step S9-2).

The determination controller 224 then sets the switching SW100 to a state ST4 (step S9-3). In the state ST4, the switching element SW100 is switched to the terminal CP3. Thus, the upper-side intermediate voltage Vref2 from the reference voltage outputter 221c is fed to the comparator 223.

In this case, the comparator 223 compares the upper-side intermediate voltage Vref2 and the terminal voltage V1 of one of the battery cells 10, and outputs a logical “1” or “0” signal representing a comparison result L12. The determination controller 224 acquires the comparison result L12 of the upper-side intermediate voltage Vref2 and the terminal voltage V1 of one of the battery cell 10 (step S9-4).

The determination controller 224 then sets the switching elements SW01, SW02, SW11, SW12, SW21, SW22, SW31, SW32, and SW100 to states ST5, ST6, ST7, and ST8 in this order (step S9-5). In the state ST5, the switching elements SW01, SW02, SW11, SW12, SW21, SW22, SW31, and SW32 are set to OFF. Thus, the capacitor C1 is separated from the battery cell 10.

In the state ST6, the switching elements SW02, SW12, SW21, and SW22 are turned on. Thus, the capacitor C1 is charged with the terminal voltage V2 of the other battery cell 10.

In the state ST7, the switching elements SW21 and SW22 are then turned off. Thus, the capacitor C1 is separated from the other battery cell 10.

Then, in the state ST8, the switching elements SW31 and SW32 are turned on. Thus, a voltage of the capacitor C1 is fed as the terminal voltage V2 of the other battery cell 10 to the comparator 223.

In this case, the comparator 223 compares the upper-side intermediate voltage Vref2 and the terminal voltage V2 of the other battery cell 10, and outputs a logical “1” or “0” signal representing a comparison result L22. The determination controller 224 acquires the comparison result L22 of the upper-side intermediate voltage Vref2 and the terminal voltage V2 of the other battery cell 10 (step S9-6).

The determination controller 224 then sets the switching SW100 to a state ST9 (step S9-7). In the state ST9, the switching element SW100 is switched to the terminal CP2. Thus, the lower-side intermediate voltage Vref1 from the reference voltage outputter 221b is fed to the comparator 223.

In this case, the comparator 223 compares the lower-side intermediate voltage Vref1 and the terminal voltage V2 of the other battery cell 10, and outputs a logical “1” or “0” signal representing a comparison result L21. The determination controller 224 acquires the comparison result L21 of the lower-side intermediate voltage Vref1 and the terminal voltage V2 of the other battery cell 10 (step S9-8).

The determination controller 224 then sets the switching elements SW01, SW02, SW11, SW12, SW21, SW22, SW31, SW32, and SW100 to a state ST10 (step S9-9). In the state ST10, the switching elements SW01, SW02, SW11, SW12, SW21, SW22, SW31, and SW32 are set to OFF. Thus, the capacitor C1 is separated from the battery cell 10.

Finally, the determination controller 224 determines the voltage range LI of one of the battery cells 10 from the acquired comparison results L11 and L12 while determining the voltage range L2 of the other battery cell 10 from the acquired comparison results L21 and L22 (step S9-10).

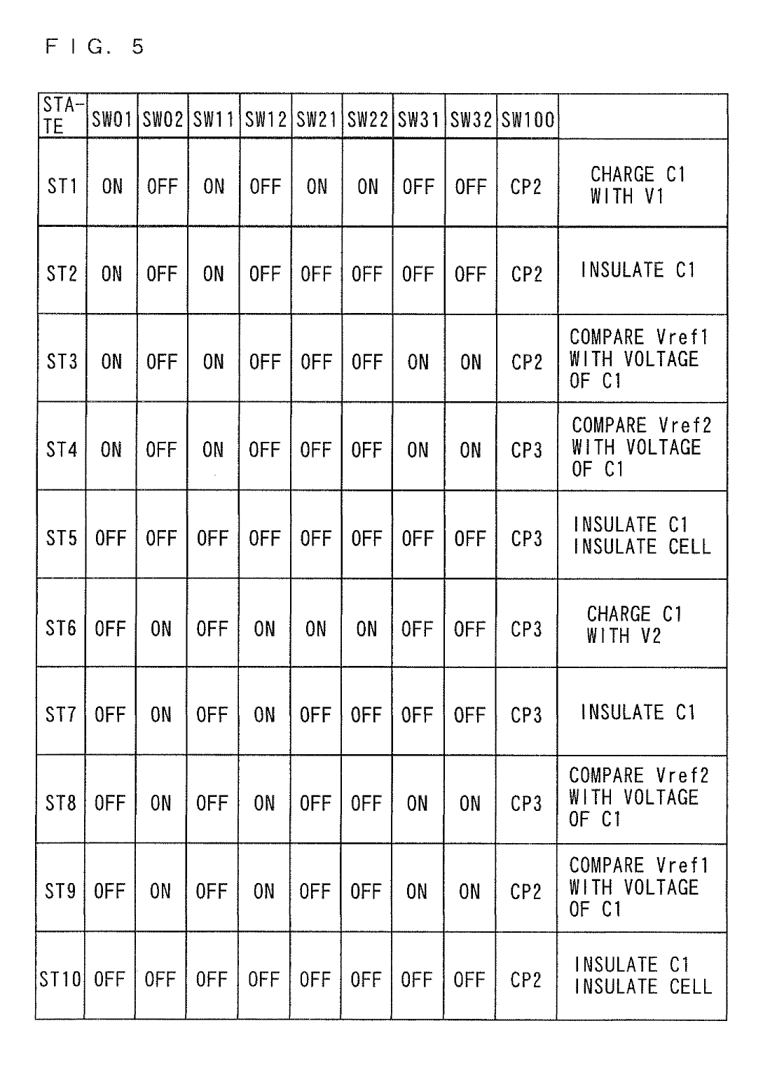

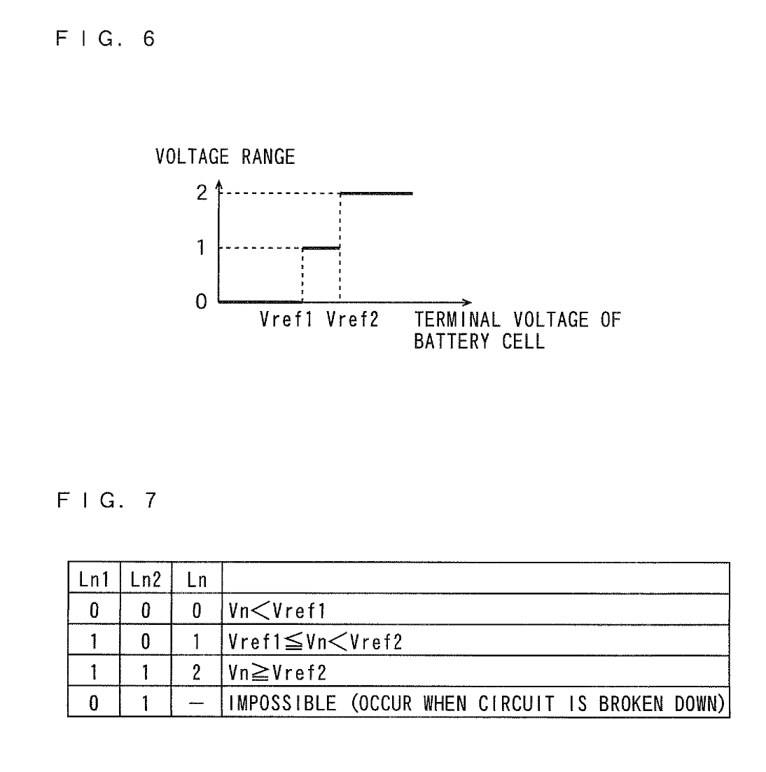

FIG. 6 is a diagram illustrating a relationship between the terminal voltage of the battery cell 10 and a voltage range. As illustrated in FIG. 6, a voltage range “0” is less than the lower-side intermediate voltage Vref1, a voltage range “1” is in a range of not less than the lower-side intermediate voltage Vref1 and less than the upper-side intermediate voltage Vref2, and the voltage range “2” is not less than the upper-side intermediate voltage Vref2. FIG. 7 is a diagram illustrating a relationship between a comparison result of the comparator 223 and a voltage range.

In FIG. 7, n is a positive integer for specifying each of the plurality of battery cells 10. In this example, Ln1 and Ln2 are respectively the comparison results L11 and L12 corresponding to one of the battery cells 10 or the comparison results L21 and L22 corresponding to the other battery cell 10, and Vn is the terminal voltage V1 of one of the battery cells 10 or the terminal voltage V2 of the other battery cell 10.

If both the comparison results Ln1 and Ln2 of the comparator 223 are logical “0”, as illustrated in FIG. 7, the determination controller 224 determines that the voltage range Ln is “0”. This indicates that the terminal voltage Vn of the battery cell 10 is less than the lower-side intermediate voltage Vref1.

If the comparison result Ln1 of the comparator 223 is logical “1”, and the comparison result Ln2 thereof is logical “0”, the determination controller 224 determines that the voltage range Ln is “1”. This indicates that the terminal voltage Vn of the battery cell 10 is not less than the lower-side intermediate voltage Vref1 and less than the upper-side intermediate voltage Vref2.

Further, if both the comparison results Ln1 and Ln2 of the comparator 223 are logical “1”, the determination controller 224 determines that the voltage range Ln is “2”. This indicates that the terminal voltage Vn of the battery cell 10 is not less than the upper-side intermediate voltage Vref2.

If the comparison result Ln1 of the comparator 223 is logical “0”, and the comparison result Ln2 thereof is logical “1”, the determination controller 224 does not determine the voltage range Ln. This indicates that the terminal voltage Vn of the battery cell 10 exceeds the upper-limit intermediate voltage Vref2 while being less than the lower-side intermediate voltage Vref1. Such a situation is considered to occur when the reference voltage unit 221, the differential amplifier 222, or the comparator 223 is broken down.

In step S9-10 illustrated in FIG. 4, it is determined in which of the voltage ranges “0”, “1”, and “2” the terminal voltage V1 of one of the battery cells 10 and the terminal voltage V2 of the other battery cell 10 exist based on the relationship illustrated in FIG. 7.

In this example, the voltage range determiner 220 has the function of a charge amount detector that detects overcharge and overdischarge of the battery cell 10. FIG. 3B is a block diagram illustrating a configuration of the voltage range determiner 220 illustrated in FIG. 3A.

As illustrated in FIG. 3B, the voltage range determiner 220 includes a charge amount detector 220b and the reference voltage outputters 221b and 221c. Conventionally, the charge amount detector 220b having a configuration surrounded by a broken line in FIG. 3B, for example, has been used to detect charge/discharge and overdischarge of the battery cell 10.

In this example, the conventional charge amount detector 220b is diverted into the voltage range determiner 220 by adding the reference voltage outputter 221b that outputs the lower-side intermediate voltage Vref1 and the upper-side intermediate voltage Vref2 that outputs the upper-side intermediate voltage Vref2 to the conventional charge amount detector 220b. An operation of the conventional charge amount detector 220b will be described below.

The charge amount detector 220b includes the reference voltage outputters 221a and 221d, the differential amplifier 222, the comparator 223, the determination controller 224, the plurality of switching elements SW1, SW2, SW11, SW12, SW21, SW22, SW31, SW32, and SW100, and the capacitor C1. The reference voltage outputters 221a and 221d respectively output the lower-limit voltage Vref_UV and the upper-limit voltage Vref_OV as reference voltages to the terminals CP1 and CP4.

The switching element SW100 is switched to the terminal CP1 so that the lower-limit voltage Vref_UV from the reference voltage outputter 221a is fed to the comparator 223. In this state, the terminal voltage of each battery cell 10 is fed to the comparator 223 via the capacitor C1 and the differential amplifier 222 so that the lower-limit voltage Vref_UV and the terminal voltage of each battery cell 10 are compared with each other. Similarly, the switching element SW100 is switched to the terminal CP4 so that the upper-limit voltage Vref_OV from the reference voltage outputter 221d is fed to the comparator 223. In this state, the terminal voltage of each battery cell 10 is fed to the comparator 223 via the capacitor C1 and the differential amplifier 222 so that the upper-limit voltage Vref_OV and the terminal voltage of each battery cell 10 are compared with each other.

If the terminal voltage of the battery cell 10 is lower than the lower-limit voltage Vref_UV, the battery cell 10 is in an overdischarge state. If the terminal voltage of the battery cell 10 is higher than the upper-limit voltage Vref_OV, the battery cell 10 is in an overcharge state.

The determination controller 224 turns off a contactor (not illustrated) connected in series with the battery module 100 if it acquires a comparison result representing such an overdischarge state or an overcharge state. Thus, charge or discharge of each battery cell 10 is stopped. As a result, each battery cell 10 can be prevented from being deteriorated by overdischarge or overcharge.

A reference voltage (the lower-limit voltage Vref_UV and the upper-limit voltage Vref_OV in this example) other than the lower-side intermediate voltage Vref1 and the upper-side intermediate voltage Vref2 of the voltage range determiner 220 illustrated in FIG. 3A is used for the conventional charge amount detector 220b as a reference voltage for detecting overcharge and overdischarge of the battery cell 10. In this example, the lower-side intermediate voltage Vref1 and the upper-side intermediate voltage Vref2 are added as a reference voltage to the voltage range determiner 220 so that the voltage range can be determined while preventing an increase in cost.

(5) SOC Calculation Processing for Battery Cell

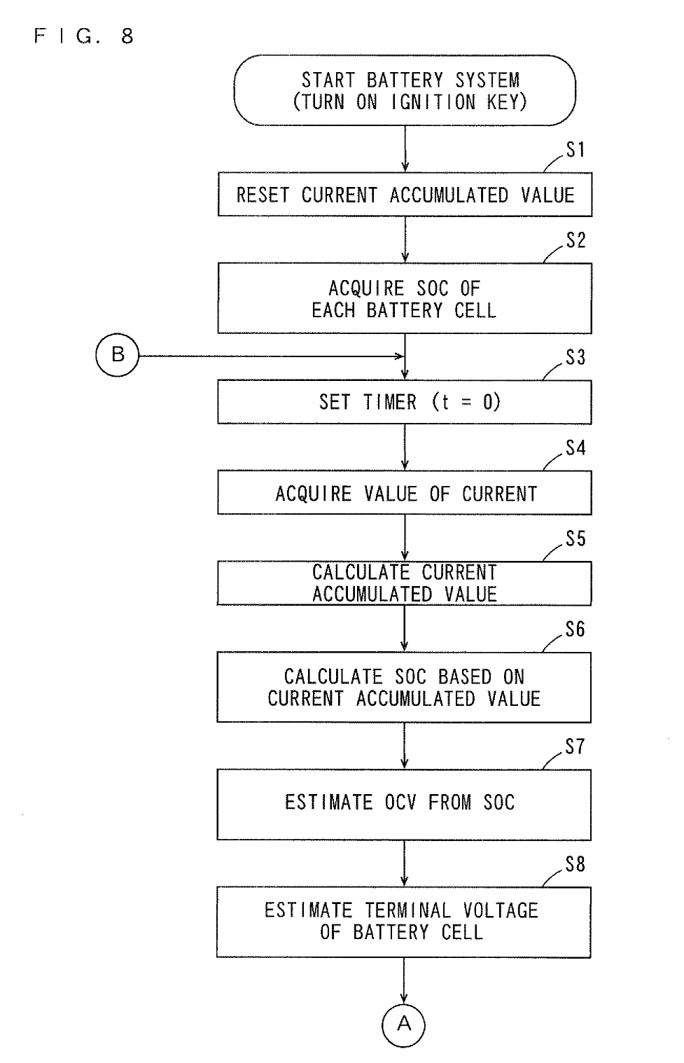

SOC calculation processing for the battery cell 10 by the battery control device 200 will be described. FIGS. 8 to 10 are flowcharts illustrating the SOC calculation processing by the battery control device 200. In the present embodiment, the CPU executes an SOC calculation processing program stored in the memory so that SOC calculation processing is performed.

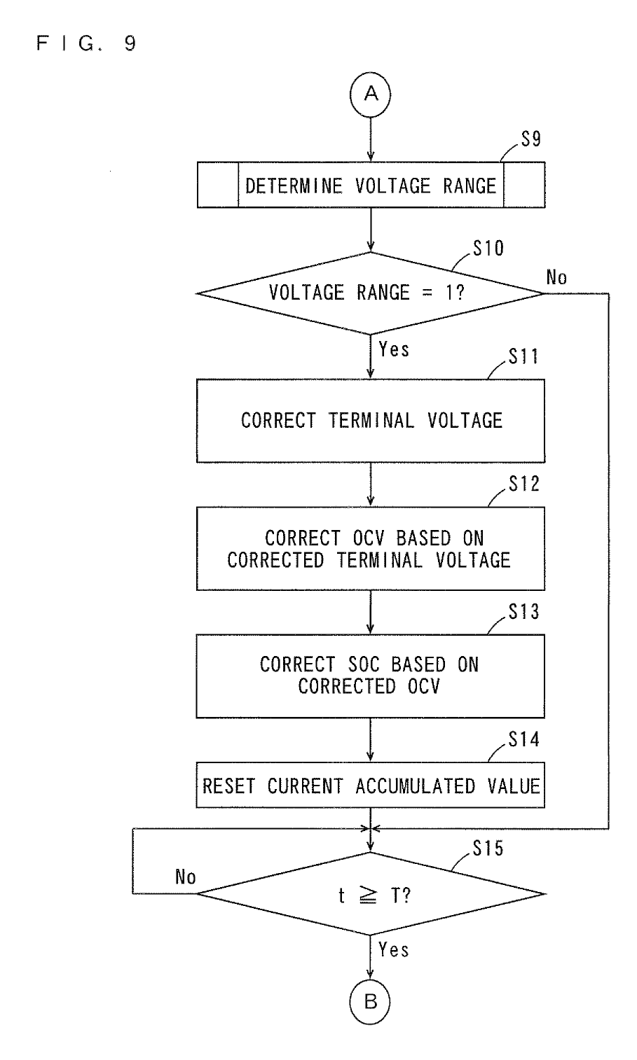

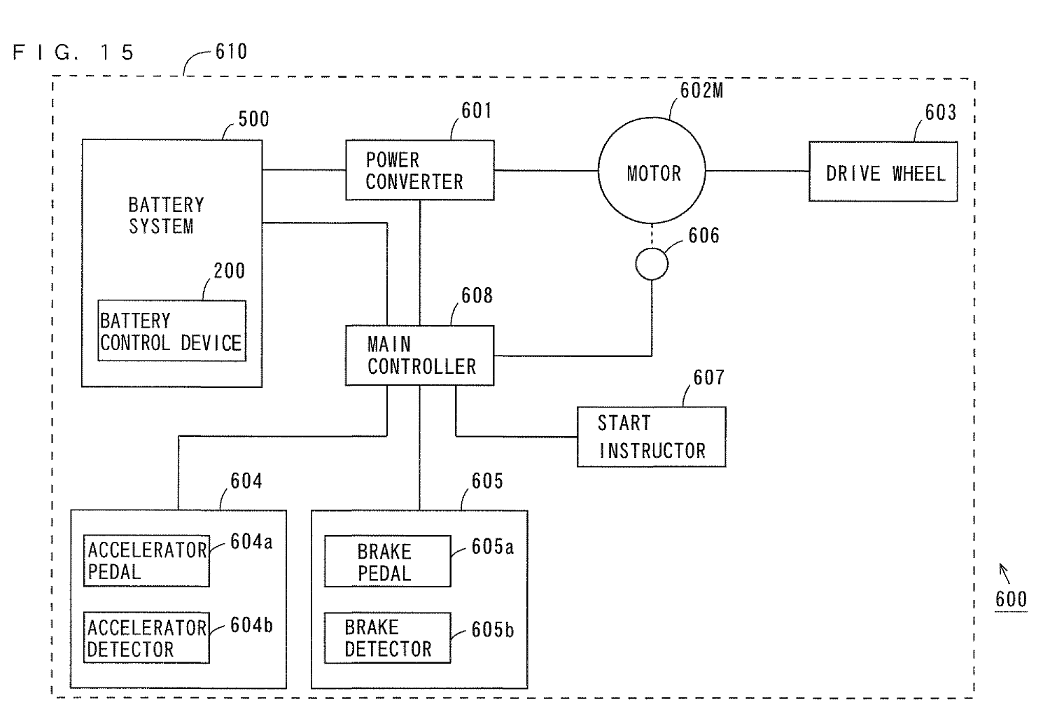

As illustrated in FIGS. 8 and 9, when an ignition key of a start instructor 607 (FIG. 15, described below) in the electric automobile 600 is turned on, the battery system 500 is started, and the voltage corrector 246 resets a current accumulated value calculated by the accumulator 242 (step S1). The SOC calculator 243 then acquires the SOC of each battery cell 10 from the storage 241 (step S2). The storage 241 stores a value of the SOC acquired when the ignition key is turned off in the previous SOC calculation processing. The voltage corrector 246 sets a timer (step S3). Thus, the timer starts to measure an elapsed time. The timer is set so that a measured value t becomes zero.

Then, the current value calculator 232 acquires values of the currents flowing through the plurality of battery cells 10 (step S4). The accumulator 242 accumulates the values of the currents acquired by the current value calculator 232, to calculate a current accumulated value (step S5). The SOC calculator 243 calculates the SOC at the current time point based on the calculated current accumulated value and the acquired SOC (step S6). When a value of the SOC at the previous time point of the i-th battery cell 10 is SOC (i) [%], the current accumulated value is ΣI [Ah], and a full charge capacity of the i-th battery cell 10 is C(i) [Ah], a value SOC_new(i) of the SOC at the current time point of the i-th battery cell 10 is calculated by the following equation (1), for example, where i is any integer from 1 to a value representing the number of battery cells 10:

SOC_new(i)=SOC(i)+ΣI/C(i)[%] (1)

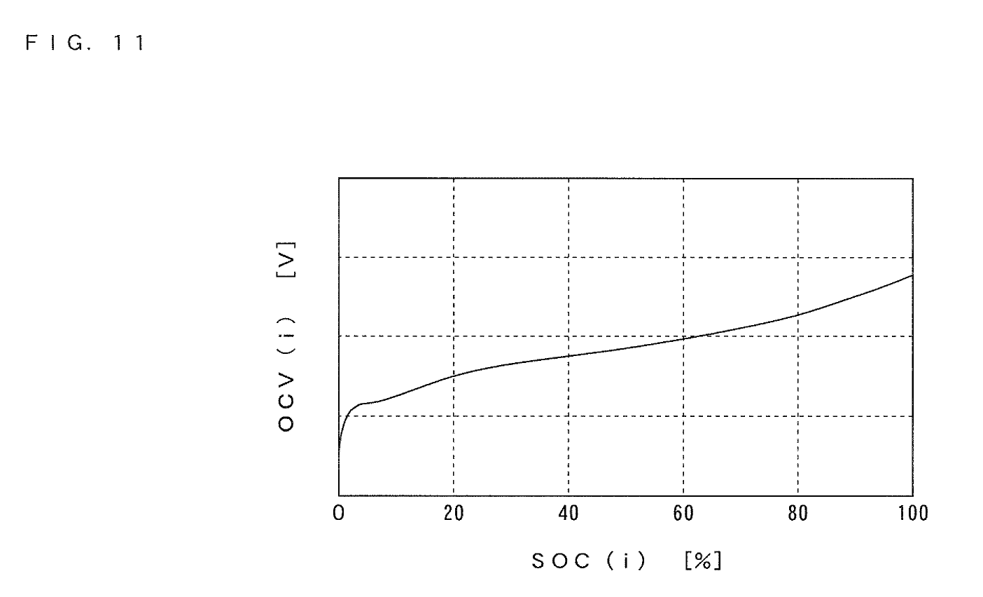

The OCV estimator 244 then estimates the OCV at the current time point of each battery cell 10 from the calculated SOC at the current time point (step S7). FIG. 11 illustrates a relationship between respective values of the SOC and the OCV of the i-th battery cell 10. The relationship illustrated in FIG. 11 is previously stored in the OCV estimator 244. The OCV of each battery cell 10 is estimated by referring to the relationship illustrated in FIG. 11, for example. The relationship between the SOC and the OCV of the battery cell 10 may be stored as a function or may be stored in a tubular form.

The voltage estimator 245 estimates the terminal voltage at the current time point of each battery cell 10 from the OCV at the current time point (step S8). When a value of the OCV at the current time point of the i-th battery cell 10 is V0(i) [V], a value of the current flowing through the plurality of battery cells 10 is I [A], and an internal impedance of the i-th battery cell 10 is Z(i) [0], a value Vest(i) of a terminal voltage at the current time point of the i-th battery cell 10 is estimated by the following equation (2), for example:

Vest(i)=V0(i)+I×Z(i)[V] (2)

Here, the value I of the current is positive at the time of charge, and is negative at the time of discharge. A previously measured value may be used as the internal impedance of each battery cell 10. Alternatively, the terminal voltage of each battery cell 10 and the current flowing through the plurality of battery cells 10 may be measured when the battery system 500 is connected to the battery charger 400, as described below, to calculate the internal impedance from a relationship between the terminal voltage and the current. In this case, the internal impedance is stored in the storage 241.

The determination controller 224 then determines a voltage range (step S9), as illustrated in FIG. 4. The voltage corrector 246 determines whether the voltage range is “1” or not (step S10). If the voltage range is “1”, i.e., if the terminal voltage of each battery cell 10 is not less than the lower-side intermediate voltage Vref1 and less than the upper-side intermediate voltage Vref2, the voltage corrector 246 corrects the terminal voltage at the current time point of each battery cell 10 in the following method (step S11). Letting a be a smoothing coefficient, a value Vest_new(i) of the terminal voltage after the correction of the i-th battery cell 10 is calculated by the following equation (3), for example. The smoothing coefficient α is not less than zero nor more than one:

Vest_new(i)=α×Vest(i)+(1−α)×(Vref1+Vref2)/2[V] (3)

The voltage corrector 246 corrects the OCV at the current time point of each battery cell 10 in the following method based on the corrected terminal voltage at the current time point of the battery cell 10 (step S12). A value V0_new(i) of the OCV after the correction of the i-th battery cell 10 is calculated by the following equation (4), for example.

V0_new(i)=V0(i)+(Vest_new(i)−Vest(i))[V] (4)

Further, the voltage corrector 246 corrects the SOC at the current time point of each battery cell 10 based on the corrected OCV at the current time point (step S13). The SOC at the current time point after the correction is found by referring to the relationship illustrated in FIG. 11, for example.

The voltage corrector 246 then resets the current accumulated value calculated by the accumulator 242 (step S14). Then, the voltage corrector 246 waits until the measured value t of the timer reaches a predetermined time T (step S15). When the measured value t of the timer reaches the predetermined time T, the voltage corrector 246 returns to the processing in step S3. The SOC of each battery cell 10, which is stored in the storage 241, is replaced with the SOC at the current time point of the battery cell 10, which has been corrected by the voltage corrector 246, to repeat the processing from step S3 to step S15.

If the voltage range is not “1” in step S10, i.e., if the voltage range is “0” (if the terminal voltage of each battery cell 10 is less than the lower-side intermediate voltage Vref1) or is “2” (if the terminal voltage of each battery cell 10 is not less than the upper-side intermediate voltage Vref2), it is considered that the terminal voltage of each battery cell 10 is not appropriately corrected by the foregoing equation (3). Therefore, the voltage corrector 246 proceeds to the processing in step S15 without correcting the terminal voltage, correcting the OCV, and correcting the SOC.

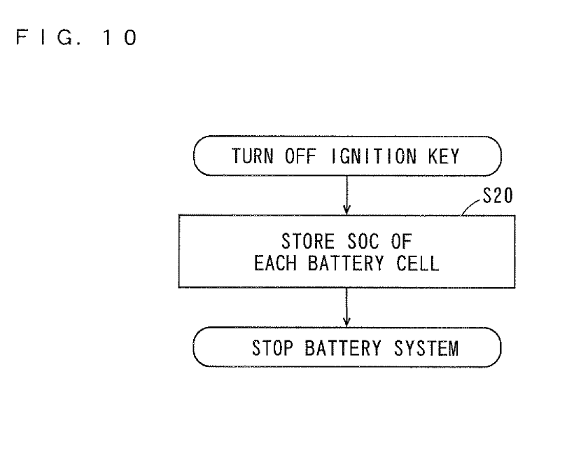

On the other hand, when the ignition key of the start instructor 607 in the electric automobile 600 (FIG. 15, described below) is turned off, the SOC calculator 243 stores the SOC at the current time point of each battery cell 10 in the storage 241 (step S20), as illustrated in FIG. 10. In this case, the SOC stored in the storage 241 is updated to the SOC at the current time point. Then, the battery system 500 is stopped.

(6) SOC Calculation Processing for Battery Cell During Charge

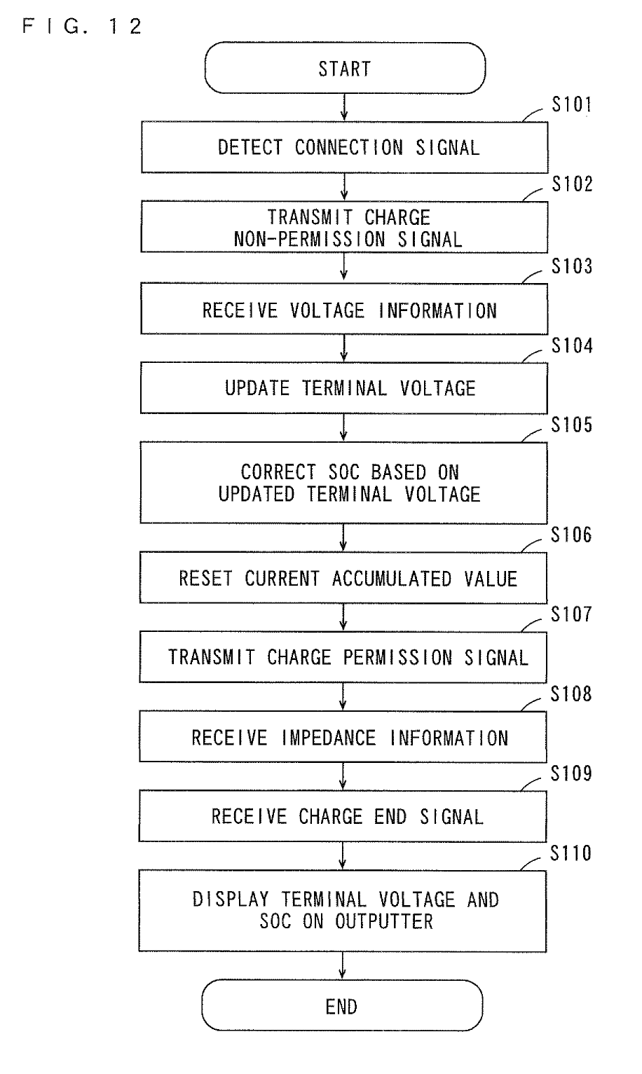

SOC calculation processing for the battery cell 10 by the battery control device 200 during charge will be described. FIG. 12 is a flowchart of the SOC calculation processing by the battery control device 200 during charge. In the present embodiment, the CPU executes an SOC calculation processing program stored in the memory so that the SOC calculation processing is performed.

The SOC calculation processing for the battery cell described in FIGS. 8 to 10 is performed at the same time during charge.

When the battery system 500 is connected to the battery charger 400, the connection determiner 270 receives a connection signal indicating that the battery system 500 is connected to the battery charger 400 from the battery charger 400 (step S101). The communicator 250 then transmits a charge non-permission signal indicating that the battery cell 10 is not permitted to be charged to the battery charger 400 (step S102). Thus, the voltage detector 320 in the battery charger 400 detects the terminal voltage of each battery cell 10, and voltage information representing the detected terminal voltage is transmitted from the battery charger 400, as described below. The communicator 250 in the battery control device 200 receives the voltage information representing the terminal voltage of each battery cell 10 from the battery charger 400 (step S103).

The voltage value updater 260 updates, based on the terminal voltage of each battery cell 10, which has been obtained from the voltage information, the terminal voltage at the current time point of the battery cell 10 (step S104). When a value of the terminal voltage of the i-th battery cell 10, which has been obtained from the voltage information, is Vbat(i) [V], and a value of the terminal voltage at the current time point of the i-th battery cell 10 is Vest(i) [V], and letting β be a smoothing coefficient, a value Vest_new(i) of the terminal voltage at the current time point after the updating of the i-th battery cell 10 is calculated by the following equation (5), for example. The smoothing coefficient β is not less than zero nor more than one.

Vest_new(i)=β×Vbat(i)+(1−β)×Vest(i)[V] (5)

Here, the terminal voltage Vest at the current time point before the updating is the terminal voltage Vest_new(i) corrected based on the foregoing equation (3) in step S11 illustrated in FIG. 9 or the terminal voltage Vest(i) (when not corrected) estimated by the foregoing equation (2) in step S8 illustrated in FIG. 8. The terminal voltage actually detected by the voltage detector 320 in the battery charger 400 is more accurate than the terminal voltage calculated based on the current accumulated value. Therefore, a more accurate terminal voltage is obtained by the foregoing processing.

The voltage corrector 246 corrects the SOC at the current time point of each battery cell 10 based on the updated terminal voltage at the current time point (step S105). The SOC is corrected in the following procedure. First, the voltage corrector 246 corrects the OCV at the current time point of each battery cell 10 based on the updated terminal voltage at the current time point of the battery cell 10. The OCV at the current time point is the value V0_new(i) of the OCV calculated based on the foregoing equation (4) in step S12 illustrated in FIG. 9 or the value of the OCV (when not corrected) estimated in step S7 illustrated in FIG. 8. A value V0_new(i) of the OCV at the current time point after the correction of the i-th battery cell 10 is calculated by the following equation (6), for example:

V0_new(i)=V0(i)+(Vest_new(i)−Vest(i))[V] (6)

Then, the voltage corrector 246 corrects the SOC at the current time point of each battery cell 10 based on the corrected OCV at the current time point. The SOC at the current time point is the SOC corrected in step S13 illustrated in FIG. 9 or the SOC calculated in step S6 illustrated in FIG. 8. The SOC at the current time point after the correction is found by referring to the relationship illustrated in FIG. 11, for example. Thus, a more accurate SOC is obtained based on a more accurate terminal voltage and a more accurate OCV.

Further, the voltage corrector 246 resets the current accumulated value calculated by the accumulator 242 in step S5 illustrated in FIG. 8 (step S106). Then, in the SOC calculation processing for the battery cell performed at the same time, the SOC at the time point is calculated and corrected based on the more accurate SOC.

The communicator 250 transmits a charge permission signal indicating that the battery cell 10 is permitted to be charged to the battery charger 400 (step S107).

Then, the communicator 250 receives impedance information representing the internal impedance of each battery cell 10 from the battery charger 400 (step S108). Then, in step S8 in the SOC calculation processing for the battery cell, the terminal voltage is calculated by the foregoing equation (2) based on a more accurate internal impedance. The SOC during charge by the battery charger 400 is calculated by the processing in steps S3 to S15 illustrated in FIGS. 8 and 9.

The communicator 250 receives a charge end signal representing the end of charge of the battery cell 10 from the battery charger 400 (step S109).

Finally, the voltage value updater 260 displays the updated terminal voltage of each battery cell 10 on the outputter 280 while the voltage corrector 246 displays the corrected SOC of each battery cell 10 on the outputter 280 (step S110).

(7) Charge and Battery Cell Voltage Detection Processing

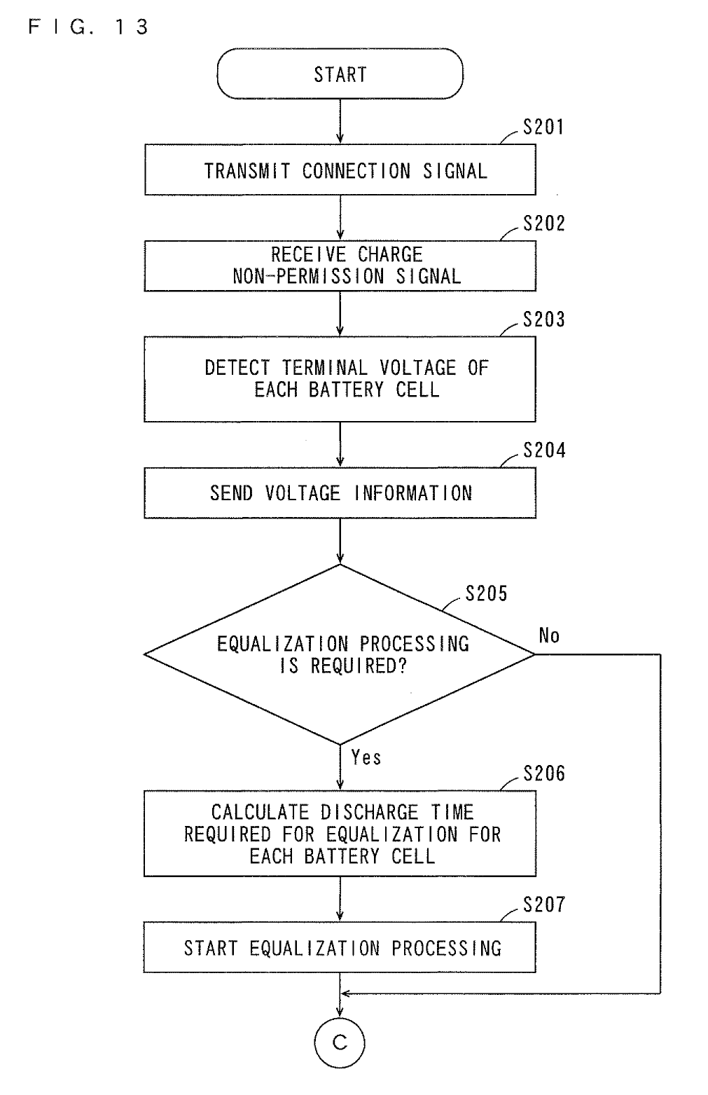

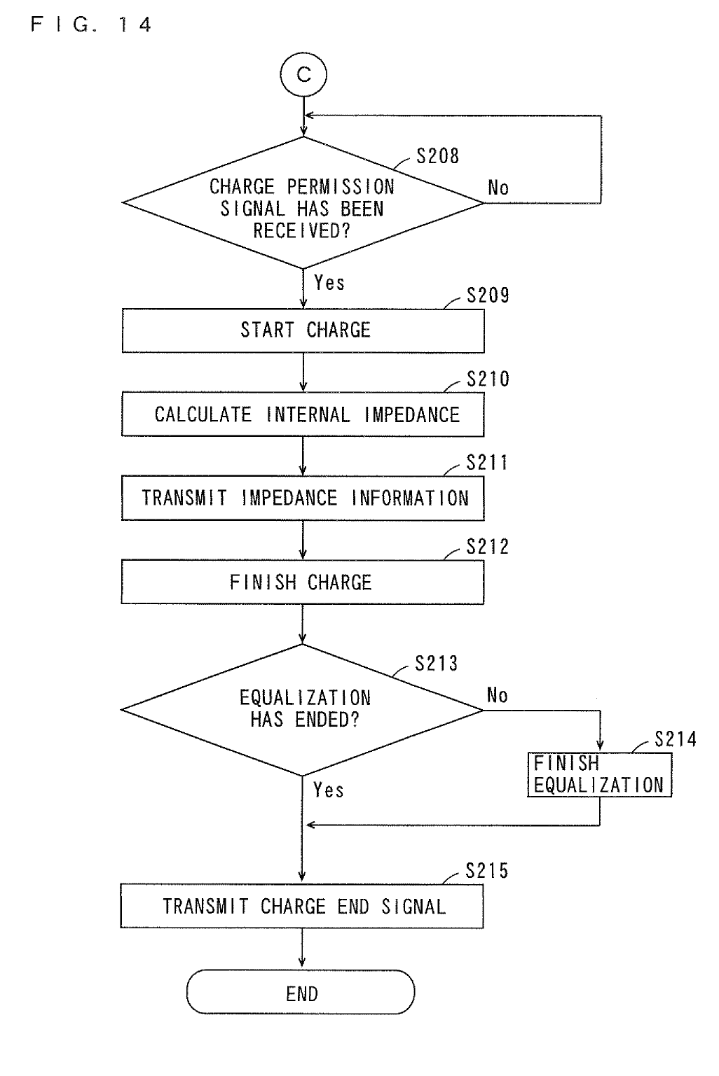

Charge and battery cell voltage detection processing for the battery cell 10 by the charge control device 300 illustrated in FIG. 1 will be described. FIGS. 13 and 14 are flowcharts of the charge and battery cell voltage detection processing for the battery cell 10 by the charge control device 300. In the present embodiment, the CPU constituting the controller 360 executes a charge and battery cell voltage detection processing program stored in the memory so that the charge and battery cell voltage detection processing is performed.

When the battery system 500 is connected to the battery charger 400, the communicator 350 transmits a connection signal indicating that the battery system 500 is connected to the battery charger 400 to the battery system 500 (step S201). Then, the communicator 350 receives a charge non-permission signal indicating that the battery cell 10 is not permitted to be charged from the battery system 500 (step S202).

The voltage detector 320 detects the terminal voltage of each battery cell 10 (step S203).

Thus, the terminal voltage of the battery cell 10 is accurately detected with no charging current flowing through the plurality of battery cells 10. In this case, the terminal voltage is equal to an open voltage (OCV). Then, the communicator 350 transmits voltage information representing the terminal voltage of each battery cell 10 to the battery system 500 (step S204).

Then, the controller 360 determines whether equalization processing is required or not for each battery cell 10 (step S205). When the terminal voltage of the battery cell 10 having the lowest terminal voltage out of all the battery cells 10 is Vmin [V], and the terminal voltage of the battery cell 10 having the highest terminal voltage is Vmax [V], the necessity of the equalization processing is determined by the following equation (7), for example:

Vmax−Vmin>δ1 (7)

In the foregoing equation (7), δ1 is a positive constant previously determined, and is set to δ1=50 [mV], for example, in this example. If the foregoing equation (7) is not satisfied, the controller 360 determines that the equalization processing is not required. In the case, the controller 360 proceeds to processing in step S208.

On the other hand, if the foregoing equation (7) is satisfied, the controller 360 determines that the equalization processing is required. In the case, the controller 360 determines the battery cell 10 requiring equalization processing. When a value of the terminal voltage of the i-th battery cell 10 is V(i) [V], the necessity of the equalization processing is determined by the following equation (8):

V(i)−Vmin>δ2 (8)

In the foregoing equation (8), 62 is a positive constant previously determined, and is set to δ2=20 [mV], for example, in this example. The controller 360 determines that the equalization processing is required for the battery cell 10 satisfying the foregoing equation (8). The controller 360 determines that the equalization processing is not required for the battery cell 10 not satisfying the foregoing equation (8).

The controller 360 calculates a discharge time required for equalization for each of all the battery cells 10 satisfying the foregoing equation (8). The discharge time required for equalization is a period of time required until a value V(i) [V] of the terminal voltage of the i-th battery cell 10 becomes substantially equal to the terminal voltage Vmin [V] of the battery cell 10 having the lowest terminal voltage by discharge.

Then, the controller 360 starts the equalization processing for all the battery cells 10 satisfying the foregoing equation (8) (step S207). The controller 360 turns on the switching element SW connected to each battery cell 10 requiring equalization processing. Thus, a part of electric charges with which each battery cell 10 requiring equalization processing is charged is discharged via the resistor R. A resistance value of the resistor R illustrated in FIG. 2 is preferably set so that the discharge time required for equalization becomes shorter than a period of time required until the charge of the battery cell 10 ends. The controller 360 sequentially turns off the switching elements SW connected to the battery cells 10 after an elapse of the discharge time required for equalization. The equalization processing may be performed continuously even after charge in the subsequent step S208 depending on the charge state of each battery cell 10.

In this way, the open voltages of all the battery cells 10 are kept substantially equal. Thus, some of the battery cells 10 can be prevented from being overcharged and overdischarged. As a result, the battery cell 10 can be prevented from being deteriorated.

The controller 360 then determines whether the communicator 350 has received a charge permission signal indicating that the battery cell 10 is permitted to be charged or not from the battery system 500 (step S208). If the communicator 350 does not receive the charge permission signal, the controller 360 waits until the communicator 350 receives the charge permission signal. On the other hand, if the communicator 350 receives the charge permission signal, the charger 420 starts to charge the battery cell 10 (step S209).

The controller 360 calculates the internal impedance of each battery cell 10 (step S210). When a value of the terminal voltage of the i-th battery cell 10, which has been detected immediately before the charge is started, is Vbat_a(i) [V], a value of the terminal voltage of the i-th battery cell 10, which has been detected immediately after the charge is started, is Vbat_b(i) [V], a value of a current of the battery module 100, which has been detected immediately before the charge is started, is I_a [A], and a value of a current of the battery module 100, which has been detected immediately after the charge is started, is I_b [A], a value Z(i) of the internal impedance of the i-th battery cell 10 is calculated by the following equation (9):

Z(i)={Vbat_{—}b(i)−Vbat_{—}b(i)}/(I_{—}b−I_{—}a)[Ω] (9)

The communicator 350 transmits impedance information representing the internal impedance of each battery cell 10 to the battery system 500 (step S211). Further, when the maximum value of the terminal voltage of each battery cell 10 reaches a terminal voltage at the time of full charge (when the SOC is 100[%]), the charger 420 finishes charging the battery cell 10 (step S212).

Then, the controller 360 determines whether the equalization processing has ended or not (step S213). If the equalization processing has ended, the processing proceeds to step S215. On the other hand, if the equalization processing has not ended, the controller 360 finishes the equalization processing (step S214). The equalization processing is finished by turning off the switching elements SW connected to all the battery cells 10. Finally, the communicator 350 transmits a charge end signal representing the end of charge of the battery cell 10 to the battery system 500 (step S215).

(8) Effects

In the battery control device 200 according to the first embodiment, the voltage value calculator 240 calculates the terminal voltage of each battery cell 10 based on the current flowing through the plurality of battery cells 10. Thus, the terminal voltage of each battery cell 10 can be obtained in the battery control device 200 without providing the voltage detector for detecting the terminal voltage of the battery cell 10 in the battery control device 200.

The voltage range determiner 220 determines whether the terminal voltage of each battery cell 10 belongs to a predetermined voltage range “1” or not, and the voltage value calculator 240 corrects the terminal voltage calculated based on the current when the terminal voltage of the battery cell 10 belongs to “1”. Even when the charge control device 300 is not connected, therefore, a more accurate voltage is obtained.

Further, when the battery control device 200 is connected to the charge control device 300, the voltage information relating to the accurate terminal voltage of each battery cell 10, which has been detected by the voltage detector 320 in the charge control device 300, is transmitted from the communicator 350 in the charge control device 300 to the communicator 250. The voltage value updater 260 updates the terminal voltage, which has been calculated and corrected by the voltage value calculator 240, based on the voltage information.

As a result, the terminal voltage of each battery cell 10 can be obtained in the battery control device 200 while preventing the battery control device 200 from becoming complex in configuration and increasing in cost. The terminal voltage of each battery cell 10 obtained in the battery control device 200 can be updated to a more accurate value at any timing.

The voltage range determiner 220 determines whether the terminal voltage of each battery cell 10 belongs to the voltage range “1” or not by comparing the terminal voltage of the battery cell 10 with the lower-side intermediate voltage Vref1 and the upper-side intermediate voltage Vref2. Thus, an accurate terminal voltage of each battery cell 10 can be obtained without complicating the configuration of the battery control device 200.

Further, the connection determiner 270 determines that the charge control device 300 is connected to the battery control device 200. The terminal voltage of the battery cell 10, which has been calculated and corrected by the voltage value calculator 240 in the battery control device 200, is updated to an accurate terminal voltage, which has been detected by the voltage detector 320 in the charge control device 300. When the charge control device 300 is connected, therefore, the terminal voltage of each battery cell 10, which has been calculated based on the current in the battery control device 200, is automatically updated to an accurate terminal voltage, which has been actually detected by the voltage detector 320 in the charge control device 300.

The charge control device 300 can be used in common for the plurality of battery control devices 200 so that the overall cost of the plurality of battery control devices 200 and the charge control device 300 can be reduced.

### [2] Second Embodiment

An electric vehicle according to a second embodiment will be described below. The electric vehicle according to the present embodiment includes a battery system 500 according to the first embodiment. An electric automobile will be described as an example of the electric vehicle.

(1) Configuration and Operation

FIG. 15 is a block diagram illustrating a configuration of an electric automobile according to the second embodiment. As illustrated in FIG. 15, an electric automobile 600 according to the present embodiment includes a vehicle body 610. The vehicle body 610 is provided with a battery system 500 and an electric power converter 601 illustrated in FIG. 1, and a motor 602M serving as the load 602 illustrated in FIG. 3A, a drive wheel 603, an accelerator device 604, a brake device 605, a rotational speed sensor 606, a start instructor 607, and a main controller 608. If the motor 602M is an alternating current (AC) motor, the electric power converter 601 includes an inverter circuit. The battery system 500 includes a battery control device 200 illustrated in FIG. 1.

The battery system 500 is connected to the motor 602M via the electric power converter 601 while being connected to the main controller 608.

An SOC of each battery cell 10 (see FIG. 1) and a current flowing through the plurality of battery cells 10 are fed to the main controller 608 from the battery control device 200 in the battery system 500. The accelerator device 604, the brake device 605, the rotational speed sensor 606 are connected to the main controller 608. The main controller 608 includes a CPU and a memory, or a microcomputer, for example. Further, the start instructor 607 is connected to the main controller 608.

The accelerator device 604 includes an accelerator pedal 604a included in the electric automobile 600 and an accelerator detector 604b that detects an operation amount (a depression amount) of the accelerator pedal 604a.

When a user operates the accelerator pedal 604a with an ignition key of the start instructor 607 turned on, an accelerator detector 604b detects the operation amount of the accelerator 604a using a state where the user does not operate the accelerator pedal 604a as a basis. The detected operation amount of the accelerator pedal 604a is fed to the main controller 608.

The brake device 605 includes a brake pedal 605a included in the electric automobile 600 and a brake detector 605b that detects an operation amount (a depression amount) of the brake pedal 605a by the user. When the user operates the brake pedal 605a with the ignition key turned on, the brake detector 605b detects the operation amount. The detected operation amount of the brake pedal 605a is given to the main controller 608. The rotational speed sensor 606 detects a rotational speed of the motor 602M. The detected rotational speed is given to the main controller 608.

As described above, the SOC of each battery cell 10, the current flowing through the plurality of battery cells 10, the operation amount of the accelerator pedal 604a, the operation amount of the brake pedal 605a, and the rotational speed of the motor 602M are given to the main controller 608. The main controller 605 performs charge/discharge control of a battery module 100 and electric power conversion control of the electric power converter 601 based on these information. When the electric automobile 600 is started and accelerated based on an accelerator operation, for example, electric power from the battery module 100 is supplied to the electric power converter 601 from the battery system 500.

Further, the main controller 608 calculates a torque (a command torque) to be transmitted to the drive wheel 603 based on the given operation amount of the accelerator pedal 604a, and feeds a control signal based on the command torque to the electric power converter 601.

The electric power converter 601, which has received the above-mentioned control signal, converts electric power supplied from the battery system 500 to electric power (driving electric power) required to drive the drive wheel 603. Thus, the driving electric power, which has been obtained in the conversion by the electric power converter 601, is supplied to the motor 602M, and a torque generated by the motor 602M based on the driving electric power is transmitted to the drive wheel 603.

On the other hand, the motor 602M functions as a power generation device when the electric automobile 600 is decelerated based on a brake operation. In this case, the electric power converter 601 converts regenerated electric power, which has been generated by the motor 602M, into electric power suitable for charge of the plurality of battery cells 10, and feeds the electric power to the plurality of battery cells 10. Thus, the plurality of battery cells 10 are charged.

(2) Effects

In the electric automobile 600 according to the second embodiment, the battery control deice 200 according to the first embodiment and the battery system 500 including the same are provided. In the battery control device 200, the voltage value calculator 240 calculates the terminal voltage of each battery cell 10 based on the current flowing through the plurality of battery cells 10. Thus, the terminal voltage of each battery cell 10 can be obtained in the battery control device 200 without providing a voltage detector for detecting the terminal voltage of the battery cell 10 in the battery control device 200.

Therefore, the voltage detector for detecting the terminal voltage of each battery cell 10 need not be provided in the electric automobile 600. This can prevent the electric automobile 600 from becoming complex in configuration and increasing in cost.

(3) Another Movable Body

While an example in which the battery system 500 illustrated in FIG. 1 is loaded into the electric vehicle has been described above, the battery system 500 may be loaded into another movable body such as a ship, an airplane, an elevator, or a walking robot.

The ship, which is loaded with the battery system 500, includes a hull instead of the vehicle body 610 illustrated in FIG. 15, includes a screw instead of the drive wheel 603, includes an accelerator inputter instead of the accelerator device 604, and includes a deceleration inputter instead of the brake device 605, for example. A driver operates the acceleration inputter instead of the accelerator device 604 in accelerating the hull, and operates the deceleration inputter instead of the brake device 605 in decelerating the hull. In this case, the motor 602M is driven with electric power from the battery module 100 (FIG. 1), and a torque generated by the motor 602M is transmitted to the screw to generate an impulsive force so that the hull moves.

Similarly, the airplane, which is loaded with the battery system 500, includes an airframe instead of the vehicle body 610 illustrated in FIG. 15, includes a propeller instead of the drive wheel 603, includes an acceleration inputter instead of the accelerator device 604, and includes a deceleration inputter instead of the brake device 605, for example. The elevator, which is loaded with the battery system 500, includes a cage instead of the vehicle body 610 illustrated in FIG. 15, includes a hoist motor for a hoist rope, which is attached to the cage, instead of the drive wheel 603, includes an accelerator inputter instead of the accelerator device 604, and includes a deceleration inputter instead of the brake device 605, for example. The walking robot, which is loaded with the battery system 500, includes a body instead of the vehicle body 610 illustrated in FIG. 15, includes a foot instead of the drive wheel 603, includes an acceleration inputter instead of the accelerator device 604, and includes a deceleration inputter instead of the brake device 605, for example.

Thus, in the movable body, which is loaded with the battery system 500, a power source (motor) converts the electric power from the battery module 100 into power, and the main movable body (the vehicle body, the hull, the airframe, or the body) moves with the power. In this case, a voltage detector for detecting the terminal voltage of each battery cell 10 need not be provided in the movable body. This can prevent the movable body from becoming complex in configuration and increasing in cost.

### [3] Third Embodiment

A power supply device according to a third embodiment will be described below.

(1) Configuration and Operation

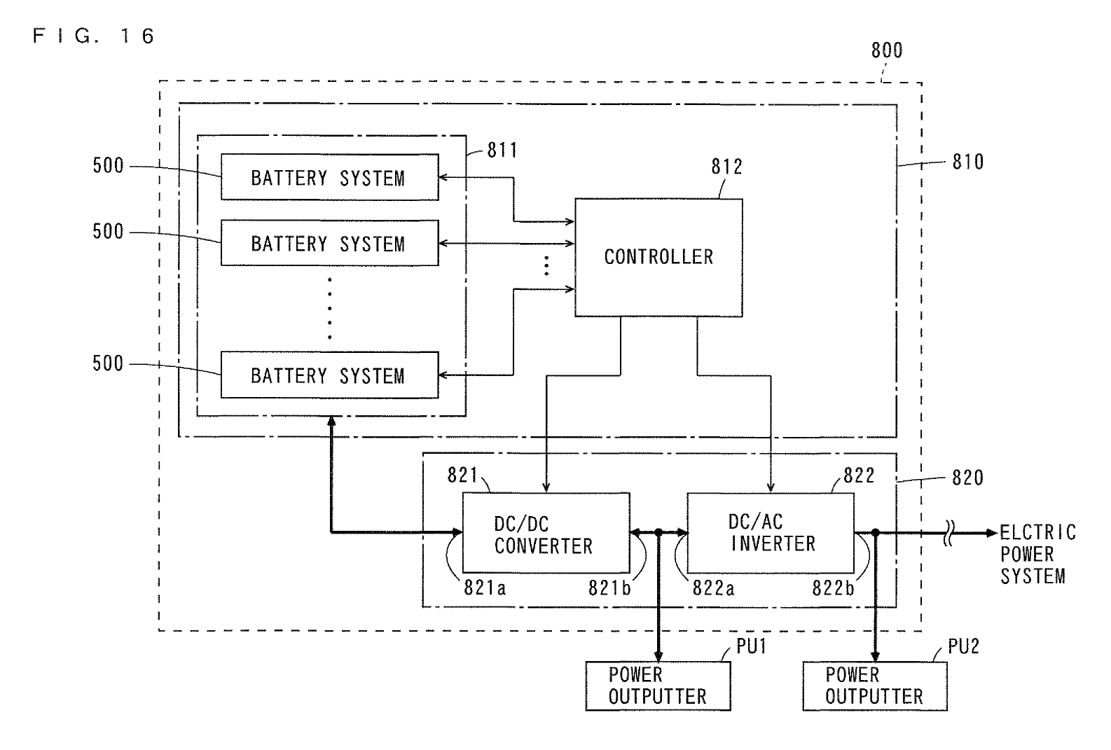

FIG. 16 is a block diagram illustrating a configuration of a power supply device according to the third embodiment.

As illustrated in FIG. 16, a power supply device 800 includes a power storage device 810 and a power conversion device 820. The power storage device 810 includes a battery system group 811 and a controller 812. The battery system group 811 includes a plurality of battery systems 500. Each of the battery systems 500 includes a plurality of battery modules 100 (FIG. 1) connected in series. The plurality of battery systems 500 may be connected in parallel, or may be connected in series.

The controller 812 includes a CPU and a memory, or a microcomputer, for example. An SOC of each battery cell 10 and a current flowing through the plurality of battery cells 10 are fed to the controller 812 from a battery control device 200 (FIG. 1) in the battery system group 811 via an outputter 280 (FIG. 1). The controller 812 calculates an amount of charge of each battery cell 10 based on the fed SOC of each battery cell 10 and the fed current flowing through the plurality of battery cells 10. The controller 812 controls the power conversion device 820 based on the amounts of charge of the plurality of battery cells 10. The controller 812 performs control, described below, as control relating to discharge or charge of the battery module 100 in the battery system 500. In the power supply device 800 illustrated in FIG. 16, the battery system 500 need not have the battery control device 200 illustrated in FIG. 1, and the controller 812 may have the function of the battery control device 200.

The power conversion device 820 includes a DC/DC (direct current/direct current) converter 821 and a DC/AC (direct current/alternating current) inverter 822. The DC/DC converter 821 has input/output terminals 821a and 821b. The DC/AC inverter 822 has input/output terminals 822a and 822b. The input/output terminal 821a of the DC/DC converter 821 is connected to the battery system group 811 in the power storage device 810. The input/output terminal 821b of the DC/DC converter 821 and the input/output terminal 822a of the DC/AC inverter 822 are connected to each other while being connected to a power outputter PU1. The input/output terminal 822b of the DC/AC inverter 822 is connected to a power outputter PU2 while being connected to another electric power system. Each of the power outputters PU1 and PU2 includes an outlet. Various loads, for example, are connected to the power outputters PU1 and PU2. The other electric power system includes a commercial power supply or a solar battery, for example. The power outputters PU1 and PU2 and the other power system are examples of an external object connected to a power supply device.

The controller 812 controls the DC/DC converter 821 and the DC/AC inverter 822 so that the battery system group 811 is discharged and charged.

When the battery system group 811 is discharged, the DC/DC converter 821 performs DC/DC (direct current/direct current) conversion for electric power fed from the battery system group 811, and the DC/AC inverter 822 performs DC/AC (direct current/alternating current) conversion therefor.

Electric power obtained in the DC/DC conversion by the DC/DC converter 821 is supplied to the power outputter PU1. Electric power obtained in the DC/AC conversion by the DC/AC inverter 822 is supplied to the power outputter PU2. Thus, DC electric power is output to the external object from the power outputter PU1, and AC electric power is output to the external object from the power outputter PU2. Further, the AC electric power obtained in the conversion by the DC/AC inverter 822 may be supplied to another electric power system.

The controller 812 performs the following control as an example of control relating to discharge of the battery module 100 in the battery system 500. When the battery system group 811 is discharged, the controller 812 determines whether the discharge of the battery system group 811 is stopped or not based on the amounts of charge of the plurality of battery cells 10. More specifically, when the amount of charge of any one of the plurality of battery cells 10 (FIG. 1) included in the battery system group 811 is smaller than a predetermined threshold value, the controller 812 controls the DC/DC converter 821 and the DC/AC inverter 822 so that the discharge of the battery system group 811 is stopped or a discharge current (or discharge electric power) is limited. Thus, each battery cell 10 is prevented from being overdischarged.

On the other hand, when the battery system group 811 is charged, the DC/AC inverter 822 performs AC/DC (alternating current/direct current) conversion for AC electric power fed from another electric power system, and the DC/DC converter 821 further performs DC/DC (direct current/direct current) conversion therefor. The electric power is fed from the DC/DC converter 821 to the battery system group 811 so that the plurality of battery cells 10 (FIG. 1) included in the battery system group 811 are charged.

The controller 812 performs the following control as an example of control relating to charge of the battery module 100 in the battery system 500.

When the battery system group 811 is charged, the controller 812 determines whether the charge of the battery system group 811 is stopped or not based on the amounts of charge of the plurality of battery cells 10, and controls the power conversion device 820 based on a determination result. More specifically, when the amount of charge of any one of the plurality of battery cells 10 (FIG. 1) included in the battery system group 811 is larger than a predetermined threshold value, the controller 812 controls the DC/DC converter 821 and the DC/AC inverter 822 so that the charge of the battery system group 811 is stopped or a charging current (or charging electric power) is limited. Thus, each battery cell 10 is prevented from being overcharged.

If electric power can be supplied between the power supply device 800 and the external object, the power conversion device 820 may include either one of the DC/DC converter 821 and the DC/AC inverter 822. If electric power can be supplied between the power supply device 800 and the external object, the power conversion device 820 need not be provided.

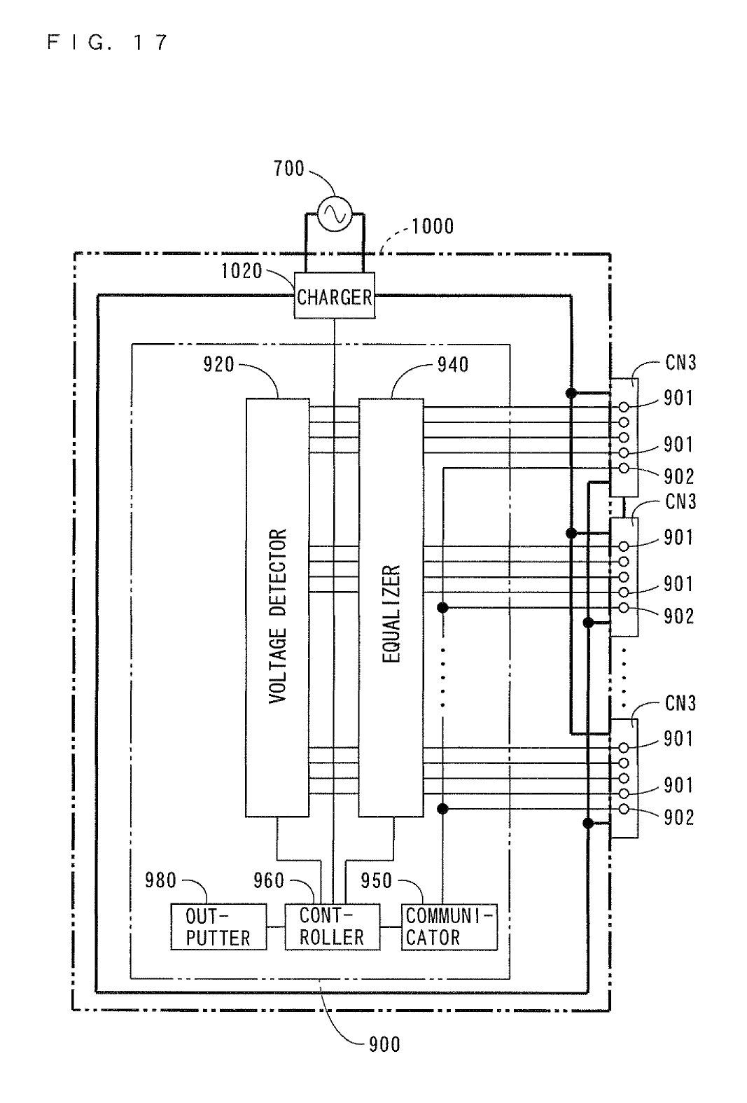

FIG. 17 is a block diagram illustrating a configuration of a battery charger 1000 corresponding to the power supply device 800 illustrated in FIG. 16. In the present embodiment, the plurality of battery systems 500 in the power supply device 800 illustrated in FIG. 16 is connected to the charger 1000 illustrated in FIG. 17 instead of the battery charger 400 illustrated in FIG. 1. Thus, the power supply device 800 and the battery charger 1000 illustrated in FIG. 17 are connected to each other, to constitute the charging system 1.

As illustrated in FIG. 17, the battery charger 1000 includes a charger 1020 and a charge control device 900. The charger 1020 has a similar configuration to that of the charger 420 illustrated in FIG. 1 except for the following points.

The charger 1020 is connected to an external power supply 700 while being connected to a plurality of external connectors CN3, described below. Thus, the charger 1020 has a function of charging the plurality of battery cells 10 included in the plurality of battery system groups 811 (FIG. 16) via the plurality of external connectors CN3. The external power supply 700 may be connected to the power conversion device 820 illustrated in FIG. 16 as an electric power system. In this case, the external power supply 700 charges the plurality of battery cells 10 included in the plurality of battery system groups 811 (FIG. 16).

The charge control device 900 includes a voltage detector 920, an equalizer 940, a communicator 950, a controller 960, and an outputter 980. The charge control device 900 includes a plurality of external connectors CN3.

The voltage detector 920 has a similar configuration to that of the voltage detector 320 illustrated in FIG. 2 except that it has a function of detecting the terminal voltage of each of the plurality of battery cells 10 included in the plurality of battery systems 500 in the battery system group 811 illustrated in FIG. 16. The equalizer 940 has a similar configuration to that of the equalizer 340 illustrated in FIG. 2 except that it has a function of equalizing open voltages of the plurality of battery cells 10 included in the plurality of battery systems 500 in the battery system group 811 illustrated in FIG. 16.

The communicator 950, the controller 960, and the outputter 980 respectively have similar configurations to those of the communicator 950, the controller 960, and the outputter 380 illustrated in FIG. 2. Each of the external connectors CN3 has a similar configuration to that of the external connector CN2 illustrated in FIG. 2 except that it has connection terminals 901 instead of the plurality of connection terminals 301 illustrated in FIG. 2 and has a connection terminal 902 instead of the connection terminal 302 illustrated in FIG. 2.

The external connector CN3 in the charge control device 900 is connected to the external connector CN1 (FIG. 1) in the battery system 500 in the battery system group 811 illustrated in FIG. 16 so that the plurality of connection terminals 201 (FIG. 1) of the external connector CN1 and the plurality of connection terminals 901 of the external connector CN3 are connected to each other while the connection terminal 202 (FIG. 1) of the external connector CN1 and the connection terminal 902 of the external connector CN3 are connected to each other.

The equalizer 940 is connected to the plurality of connection terminals 901 in the plurality of external connectors CN3. The equalizer 940 is connected to the voltage detector 920. The communicator 950 is connected to the connection terminals 902 of the plurality of external connectors CN3.

The controller 960 detects that the battery module 100 in the battery system 500 is connected to the power storage device 810 (FIG. 16) via the equalizer 940 and the voltage detector 920. The communicator 950 transmits a connection signal indicating that the battery module 100 is connected to the power storage device 810 to the connection determiner 270 (FIG. 1) in the battery system 500. In this case, a mechanical or electrical switch that operates when the battery system 500 is connected to the power storage device 810 is provided in the power storage device 810. The communicator 950 transmits the connection signal in response to the operation of the switch in the power storage device 810.

The controller 960 displays the terminal voltage of each battery cell 10 in the battery system 500 on the outputter 980 while feeding the terminal voltage of the battery cell 10 to the communicator 950. The communicator 950 transmits voltage information indicating that the terminal voltage of each battery cell 10, which has been fed from the controller 960, to the communicator 250 (FIG. 1) in the battery system 500 via the connection terminal 902 of the external connector CN3 and the connection terminal 202 of the external connector CN1 with the external connector CN3 connected to the external connector CN1.

(2) Effects

In the power supply device 800 according to the present embodiment, the controller 812 controls the supply of electric power between the battery system group 811 and the external object. Thus, some of the battery cells 10 can be prevented from being overcharged and overdischarged. As a result, the battery cells can be prevented from being deteriorated.

In the power supply device 800, the voltage information relating to the accurate terminal voltage of each battery cell 10, which has been detected by the voltage detector 920 in the charge control device 900, is transmitted from the communicator 950 to the communicator 250 in the battery control device 200. The voltage value updater 260 updates the terminal voltage, which has been calculated and corrected by the voltage value calculator 240, based on the voltage information. As a result, the terminal voltage of each battery cell 10 can be obtained in the battery control device 200 while preventing the battery control device 200 from becoming complex in configuration and increasing in cost.

In this case, a voltage detector for detecting a voltage of each battery cell need not be provided in the battery control device 200, thereby preventing the battery control device 200 from becoming complex in configuration and increasing in cost. The charge control device 900 can be used in common for a plurality of battery control devices 200. Therefore, the overall cost of the battery control device 200 and the charge control device 900 can be reduced.

### [4] Another Embodiment

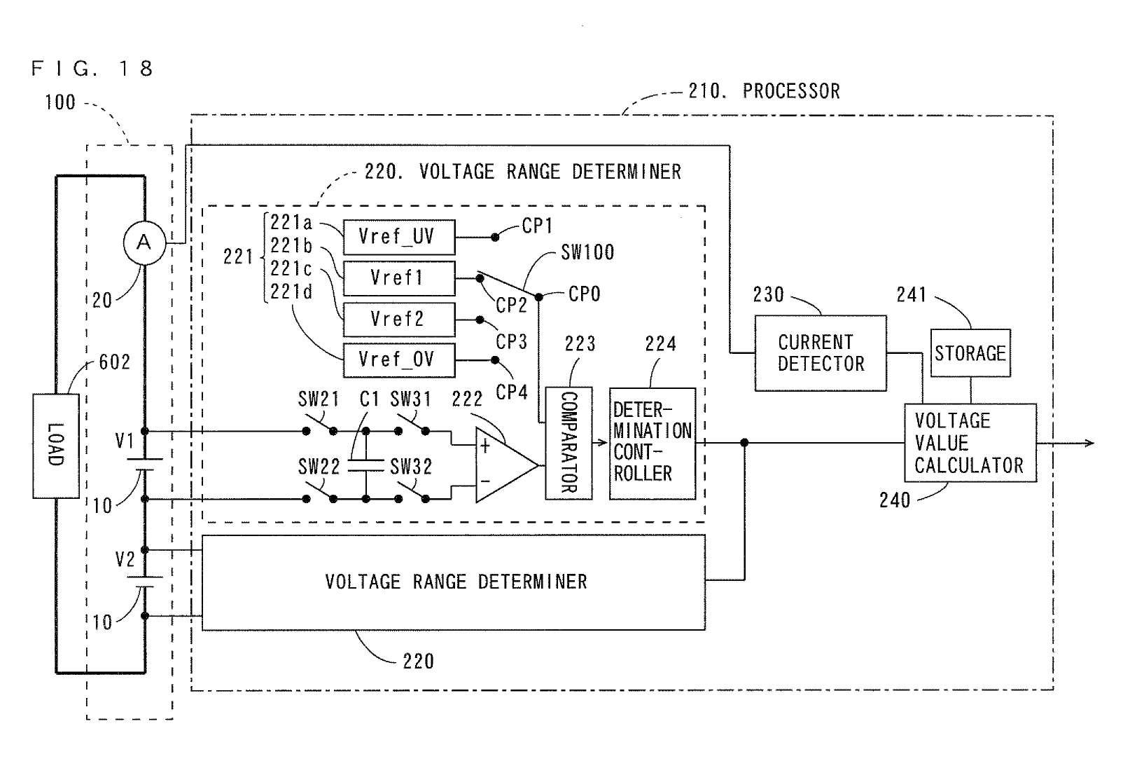

(1) While the processor 210 includes one voltage range determiner 220 in common for the plurality of battery cells 10 in the above-mentioned embodiments, the present invention is not limited to this. FIG. 18 is a block diagram illustrating another configuration of the processor 210. A processor 210 illustrated in FIG. 18 includes a plurality of voltage range determiners 220 respectively corresponding to a plurality of battery cells 10. The voltage determiner 220 illustrated in FIG. 18 is not provided with switching elements SW01, SW02, SW11, and SW12 illustrated in FIG. 3A. A configuration and an operation of another portion in the processor 210 illustrated in FIG. 18 are similar to the configuration and the operation of the processor 210 illustrated in FIG. 3A. In the processor 210 illustrated in FIG. 18, the switching elements SW01, SW02, SW11, and SW12 need not be switched so that a period of time required to determine a voltage range can be made shorter.

(2) While the terminal voltages V1 and V2 of the battery cell 10 are fed to the comparator 223 after the capacitor C1 is charged therewith in the voltage range determiner 220 in the above-mentioned embodiments, the present invention is not limited to this. If temporal changes of the terminal voltages V1 and V2 of the battery cell 10 are small, the terminal voltages V1 and V2 of the battery cell 10 may be directly fed to the comparator 223. In this case, the switching elements SW21, SW22, SW31, and SW32 and the capacitor C1 are not required. Thus, the switching elements SW21, SW22, SW31, and SW32 need not be switched, and the capacitor C1 need not be charged. Therefore, a period of time required to determine a voltage range can be made smaller.

(3) While some of the plurality of battery cells 10 are discharged at the time of equalization processing in the above-mentioned embodiments, the present invention is not limited to this. Some of the plurality of battery cells 10 may be charged at the time of equalization processing. In this case, in the equalizer 340 illustrated in FIG. 2, for example, a power supply is provided instead of the resistor R corresponding to each battery cell 10.

(4) While open voltages (OCV) are equalized as the charge states of the plurality of battery cells 10 in the above-mentioned embodiments, the present invention is not limited to this. Any of SOCs, remaining capacities, depths of discharge (DOD), current accumulated values, and differences in amounts of stored electric charges may be equalized as a charge state.

The remaining capacity of each battery cell 10 is obtained by calculating the SOC of the battery cell 10, and then multiplying the SOC by a full charge capacity previously measured, for example.

The DOD is the ratio of a chargeable capacity (a capacity obtained by subtracting the remaining capacity of the battery cell 10 from the full charge capacity thereof) to the full charge capacity of the battery cell 10, and can be expressed by (100−SOC) [%]. The DOD of each battery cell 10 is obtained by calculating the SOC of the battery cell 10 and subtracting the calculated SOC from 100.

The current accumulated value is obtained by detecting currents respectively flowing in a predetermined period at the time of charge or discharge through the plurality of battery cells 10 and accumulating their detection values, for example. In this case, a current detector for detecting a value of the current flowing through each of the plurality of battery cells 10 is provided.

Further, the difference in amount of stored electric charges is obtained by calculating an SOC of each battery cell 10, and then calculating a difference between the calculated SOC and a predetermined reference SOC (e.g., an SOC of 50[%]), as in the above-mentioned embodiments, for example.

(5) While the controller 360 simultaneously turns on the switching elements SW respectively connected to the battery cells 10 requiring equalization processing, and sequentially turns off the switching elements SW connected to the battery cells 10 after an elapse of a discharge time required for equalization in the equalization processing in the above-mentioned embodiments, the present invention is not limited to this. For example, the controller 360 may sequentially turns on the switching elements SW connected to the battery cells 10 requiring equalization processing based on the discharge time required for equalization. In this case, the equalization processing ends simultaneously for all the battery cells 10. Therefore, the controller 360 simultaneously turns off the switching elements SW respectively connected to the battery cells 10 requiring equalization processing.

(6) While the internal impedance of each battery cell 10 is calculated by the terminal voltage immediately before the start of charge, the terminal voltage immediately after the start of charge, the current immediately before the start of charge, and the current immediately after the start of charge in the above-mentioned embodiments, the present invention is not limited to this. For example, the internal impedance of each battery cell 10 may be calculated by measuring a change in the charging current and a change in the terminal voltage during charge of the battery cell 10.

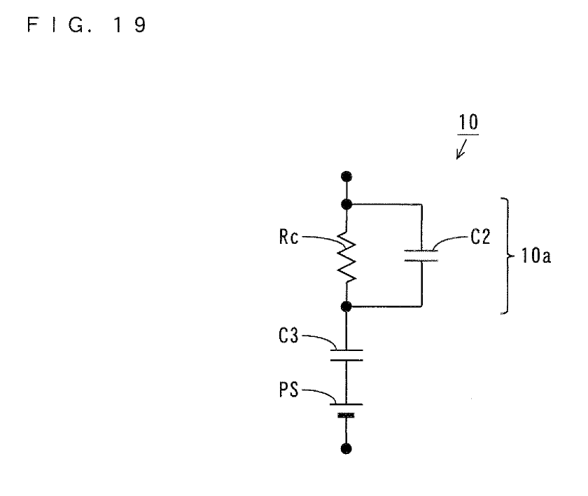

(7) While the terminal voltage of the battery cell 10 is calculated using only a resistance component as the internal impedance of the battery cell 10 in the above-mentioned embodiments, the present invention is not limited to this. FIG. 19 is a diagram illustrating an example of an equivalent circuit of a battery cell 10. In the example illustrated in FIG. 19, the equivalent circuit of the battery cell 10 includes a parallel circuit 10a of a capacitor C2 and a resistor Re, a capacitor C3, and a power supply PS. The parallel circuit 10a and the capacitor C3 are connected in series with the power supply PS. As illustrated in FIG. 19, a terminal voltage of the battery cell 10 may be calculated using the resistor Rc and the capacitors C2 and C3 as an internal impedance. Thus, the terminal voltage of each battery cell 10 is more accurately calculated.

(8) In the above-mentioned embodiments, the controller 360 in the charge control device 300 may retain a relationship among the internal impedance, the SOC, and the temperature of each battery cell 10. In this case, an accurate internal impedance of each battery cell is obtained based on the SOC and the temperature of the battery cell 10.

(9) The controller 360 may correct a relationship among the internal impedance, the SOC, and the temperature of each battery cell 10 based on the internal impedance of the battery cell 10, which has been calculated in step S210 illustrated in FIG. 14, and the corrected relationship may be transmitted to the main controller 608 in the electric automobile 600.

(10) While the battery module 100 in the above-mentioned embodiment includes three battery cells 10 in the example illustrated in FIG. 1, and two battery cells 10 in the example illustrated in FIGS. 3A and 18, the present invention is not limited to this. The battery module 100 may include a larger number of battery cells 10.

(11) While the communicator 350 in the charge control device 300 transmits the connection signal, and the communicator 250 in the battery control device 200 receives the connection signal when the battery system 500 is connected to the battery charger 400 in the above-mentioned embodiments, the present invention is not limited to this. If the battery system 500 is connected to the battery charger 400, for example, the communicator 250 in the battery control device 200 may transmit the connection signal, and the communicator 350 in the charge control device 300 may receive the connection signal. In this case, the battery system 500 is provided with a mechanical or electrical switch that operates when the battery system 500 is connected to the battery charger 400, for example. The communicator 250 transmits the connection signal in response to the operation of the switch in the battery system 500.

(12) While the controller 360 displays the terminal voltage of each battery cell 10, which has been detected by the voltage detector 320, on the outputter 380, the present invention is not limited to this. The controller 360 may display the terminal voltage of each battery cell 10, which has been detected by the voltage detector 320, as well as an SOC, which has been corrected based on the fact that a value of the terminal voltage has been updated and the detected terminal voltage of the battery cell 10.

In this case, the communicator 350 in the charge control device 300 receives SOC information relating to an SOC corrected by the voltage corrector 246 in step S105 illustrated in FIG. 12 from the communicator 250 in the battery control device 200. Then, the communicator 350 gives the received SOC information to the controller 360.

Alternatively, the controller 360 may calculate an SOC based on the terminal voltage of each of the battery cell 10, which has been detected by the voltage detector 320. In this case, the controller 360 calculates an OCV of each battery cell 10 from the terminal voltage and the internal impedance of the battery cell 10. Then, the SOC is found by referring to the relationship illustrated in FIG. 11, for example.

(13) While the charge control device 300 is provided with the equalizer 340 in the above-mentioned embodiments, the present invention is not limited to this. The charge control device 300 need not be provided with the equalizer 340, and the battery control device 200 may be provided with the equalizer 340.

(14) While an example in which the battery control device 200 and the battery system 500 are used for the electric automobile 600 in the above-mentioned embodiments, the battery control device 200 and the battery system 500 can also be used for consumer equipment including a plurality of battery cells 10 capable of charge and discharge.

### [5] Correspondences Between Constituent Elements in the Claims and Parts in Embodiments

In the following paragraph, non-limiting examples of correspondences between various elements recited in the claims below and those described above with respect to various embodiments of the present invention are explained.

In the embodiments, described above, the battery cell 10 is an example of a battery cell, and the voltage detectors 320 and 920 are examples of a voltage detector, and the charge control devices 300 and 900 are examples of an external device and a charge control device. The battery control device 200 is an example of a battery control device, the voltage value calculator 240 is an example of a calculator, the communicator 250 is an example of a receiver, and the voltage value updater 260 is an example of an updater. The voltage range determiner 220 is an example of a range determiner, the connection determiner 270 is an example of a connection determiner, and the external connector CN1 is an example of an external terminal, the connection terminal 201 is an example of a connection terminal, and the outputter 280 is an example of an outputter.

The battery system 500 is an example of a battery system, the motor 602M is an example of a motor, the drive wheel 603 is an example of a drive wheel, the electric automobile 600 is an example of an electric vehicle, the communicators 350 and 950 are examples of a transmitter, the chargers 420 and 1020 are examples of a charger, and the battery chargers 400 and 1000 are examples of a battery charger.

The vehicle body 610, the hull of the ship, the airframe of the airplane, the cage of the elevator, and the body of the walking robot are examples of a movable main body, the motor 602M, the drive wheel 603, the screw, the propeller, the hoist motor in the hoist rope, and the foot of the walking robot are examples of a power source, and the electric automobile 600, the ship, the airplane, and the walking robot are examples of a movable body. The charging system 1 is an example of a charging system, and the controller 812 is an example of a system controller. The power storage device 810 is an example of a power storage device, the power supply device 800 is an example of a power supply device, and the power conversion device 820 is an example of a power conversion device.

As each of various elements recited in the claims, various other elements having configurations or functions described in the claims can also be used.

### INDUSTRIAL APPLICABILITY

The present invention is effectively applicable to various movable bodies using electric power as a driving source, a storage device of electric power, mobile equipment, or the like.

1. A battery control device connected to a plurality of battery cells connected in series and configured to be connectable to an external device including a voltage detector that detects a voltage of each of the plurality of battery cells, the battery control device comprising:
a calculator that calculates the voltage of each battery cell based on a current flowing through said plurality of battery cells;
a receiver that receives voltage information relating to the voltage of each battery cell, which has been detected by said voltage detector, from said external device; and
an updater that updates the voltage calculated by said calculator based on said voltage information received by said receiver.

2. The battery control device according to claim 1, further comprising a range determiner that determines whether the voltage of each battery cell belongs to a predetermined voltage range or not,
wherein said calculator corrects said voltage of each battery cell based on a determination result by said range determiner.

3. The battery control device according to claim 2, wherein said range determiner determines whether the voltage of each battery cell belongs to said voltage range or not based on a comparison result between a reference voltage and the voltage of each battery cell.

4. The battery control device according to claim 1, further comprising a connection determiner that determines that said external device has been connected to said battery control device.

5. The battery control device according to claim 4, wherein said updater updates said voltage based on said voltage information in response to the determination of the connection by said connection determiner.

6. The battery control device according to claim 1, further comprising an external terminal connectable to said external device,
wherein said external terminal includes a plurality of connection terminals electrically connected to an electrode terminal of each of said plurality of battery cells.

7. The battery control device according to claim 1, further comprising an outputter that outputs information relating to a charge state of each of said plurality of battery cells.

8. A battery system comprising:
a plurality of battery cells connected in series; and
the battery control device according to claim 1 that is connected to said plurality of battery cells.

9. An electric vehicle comprising:
a plurality of battery cells connected in series;
the battery control device according to claim 1 that is connected to said plurality of battery cells;
a motor that is driven with electric power from said plurality of battery cells; and
a drive wheel that rotates with a torque generated by said motor.

10. A charge control device configured to be connectable as said external device to the battery control device according to claim 1 and a plurality of battery cells, comprising:
a voltage detector that detects a voltage of each of said plurality of battery cells; and
a transmitter that transmits voltage information relating to the voltage detected by said voltage detector to said battery control device.

11. A battery charger comprising:
a charger for charging a plurality of battery cells; and
the charge control device according to claim 10 that is configured to be connectable to said plurality of battery cells.

12. A movable body comprising:
a plurality of battery cells connected in series;
the battery control device according to claim 1 that is connected to said plurality of battery cells;
a movable main body; and
a power source that converts electric power from said plurality of battery cells into power for moving said movable main body.

13. A charging system comprising:
a plurality of battery cells connected in series;
the battery control device according to claim 1 that is connected to said plurality of battery cells; and
the battery charger according to claim 11 that is connected to said plurality of battery cells.

14. A power storage device comprising:
a plurality of battery cells connected in series;
the battery control device according to claim 1 that is connected to said plurality of battery cells; and
a system controller that performs control relating to charge or discharge of said plurality of battery cells.

15. A power supply device connectable to an external object, comprising:
the power storage device according to claim 14; and
a power conversion device that is controlled by said system controller in said power storage device and converts electric power between said plurality of battery cells in said power storage device and said external object.
